(19) United States
(12) Patent Application Publication
(10) Pub. No.: US 2014/0248490 A1
(43) Pub. Date: Sep. 4, 2014

(54) REMOVABLE WATER-DISPERSIBLE ACRYLIC PRESSURE-SENSITIVE ADHESIVE COMPOSITION AND PRESSURE-SENSITIVE ADHESIVE SHEET

(71) Applicant: NITTO DENKO CORPORATION, Ibarak-shi, Osaka (JP)

(72) Inventors: Yu Morimoto, Osaka (JP); Tatsumi Amano, Osaka (JP); Kazuma Mitsui, Osaka (JP); Kousuke Yonezaki, Osaka (JP); Kyoko Takashima, Osaka (JP)

(73) Assignee: NITTO DENKO CORPORATION, Ibarak-shi, Osaka (JP)

(21) Appl. No.: 14/352,245

(22) PCT Filed: Oct. 12, 2012
(86) PCT No.: PCT/JP2012/076438

§ 371 Date: Apr. 16, 2014

(30) Foreign Application Priority Data
Oct. 19, 2011 (JP) 2011-230087
Oct. 19, 2011 (JP) 2011-230112
Oct. 19, 2011 (JP) 2011-230113
Oct. 19, 2012 (JP) 2012-224529

(51) Int. Cl. C09J 11/08; C09J 133/08; C09J 133/12; C09J 7/02

(52) U.S. Cl. CPC C09J 11/08; C09J 7/0217; C09J 133/08; C09J 133/12
USPC 428/355 AC; 428/523; 524/377; 524/106; 524/104; 524/99

(57) ABSTRACT

Provided is a removable water-dispersible acrylic pressure-sensitive adhesive composition with which it is possible to form a pressure-sensitive adhesive layer that has excellent antistatic properties, adhesive properties, removability, removal stability, and the ability to prevent an increase in adhesive strength over time, less-staining properties on adherends, especially, the ability to prevent white staining on adherends in a high-humidity environment (the ability to prevent white staining), and appearance properties. The present invention is directed to a removable water-dispersible acrylic pressure-sensitive adhesive composition, including: an acrylic emulsion polymer including 70 to 99.5% by weight of a monomer unit derived from an alkyl(meth)acrylate and 0.5 to 10% by weight of a monomer unit derived from a carboxyl group-containing unsaturated monomer; an ionic compound; and a polyether antifoamer represented by formula (I) below.

HO—(PO)ₙ₁-(EO)ₘ₁—H (I)

In formula (I), PO represents an oxypropylene group, EO represents an oxyethylene group, m1 represents an integer of 0 to 40, n1 represents an integer of 1 or more, and EO and PO are added in a random form or a block form.

### TECHNICAL FIELD

The present invention relates to a water-dispersible acrylic pressure-sensitive adhesive composition capable of forming a removable pressure-sensitive adhesive layer. Specifically, the present invention relates to a removable water-dispersible acrylic pressure-sensitive adhesive composition capable of forming a pressure-sensitive adhesive layer having a good level of antistatic properties, adhesive properties, removability (light peelability), removal stability, ability to prevent an increase in adhesive strength over time, appearance characteristics with reduced appearance defects such as dents and less-staining properties on adherends. The present invention also relates to a pressure-sensitive adhesive sheet having a pressure-sensitive adhesive layer made from the pressure-sensitive adhesive composition.

### TECHNICAL FIELD

In the process of manufacturing or processing an optical member (optical material) such as an optical film for use as a polarizing plate, a retardation plate, or an anti-reflection plate, a surface protecting film is attached to the surface of the optical member to prevent scratching, staining, or cracking of the surface or to improve cutting workability (see Patent Documents 1 and 2). Such a surface protecting film used is generally a removable pressure-sensitive adhesive sheet including a plastic film substrate and a removable pressure-sensitive adhesive layer provided on the surface of the substrate.

Traditionally, solvent-type acrylic pressure-sensitive adhesives are used in such surface protecting film applications (see Patent Documents 1 and 2). However, such solvent-type acrylic pressure-sensitive adhesives, which contain an organic solvent, are being replaced by water-dispersible acrylic pressure-sensitive adhesives in view of working environment during application (see Patent Documents 3 to 5).

While attached to optical members, such surface protecting films are required to have sufficient adhesion. In addition, such surface protecting films are required to have good peelability (removability) because they are peeled off after use in optical member-manufacturing processes or other processes. Such surface protecting films are required not only to have relatively low peel strength (light peelability) for good removability but also to have the property that its peel strength (adhesive strength) will not increase over time after it is attached to an adherend such as an optical member (the ability to prevent an increase in peel strength (adhesive strength)).

In general, surface protecting films and optical members are made of plastic materials and therefore are highly electrically insulating and can generate static electricity when they are rubbed or peeled off. Therefore, static electricity can be generated when a surface protecting film is peeled off from an optical member such as a polarizing plate, and if a voltage is applied to a liquid crystal in a state where the generated static electricity still remains, the orientation of the liquid crystal molecule may degrade, or defects may occur in the panel.

The presence of static electricity can also create a risk of attracting dust or dirt or a risk of reducing workability. To solve this problem, therefore, surface protecting films undergo various antistatic treatments.

To suppress such electrostatic build-up, an antistatic method is disclosed which includes adding a low-molecular-weight surfactant to a pressure-sensitive adhesive and transferring the surfactant from the pressure-sensitive adhesive to the object to be protected (see, for example, Patent Document 6). In this technique, however, the added low-molecular-weight surfactant can easily bleed to the surface of the pressure-sensitive adhesive, and if this technique is applied to a surface protecting film, there can be a risk of staining on an adherend (the object to be protected).

If the pressure-sensitive adhesive layer of a surface protecting film (especially a surface protecting film for an optical member) or the like has an appearance defect such as a “dent,” there may be a problem such as a difficulty in inspecting the adherend with the surface protecting film bonded thereto. In surface protecting film applications, therefore, pressure-sensitive adhesive sheets (pressure-sensitive adhesive layers) are required to have good appearance characteristics.

Surface protecting film applications (especially, applications for protecting optical member surfaces) etc. also have the following problem. When a pressure-sensitive adhesive sheet is peeled off from the adherend (such as an optical member), the pressure-sensitive adhesive can remain on the surface of the adherend (to cause what is called an “adhesive residue”), or some components in the pressure-sensitive adhesive layer can transfer onto the surface of the adherend, so that staining can occur on the surface of the adherend, which may have an adverse effect on the optical properties of the optical member. Thus, pressure-sensitive adhesives or pressure-sensitive adhesive layers are strongly required to have less-staining properties on adherends.

As mentioned above, none of the conventional techniques can solve the problems in a well-balanced manner. In electronics related technical fields where static build-up or staining is a particularly serious problem, the conventional techniques hardly address demands for further improvement of antistatic surface protecting films.

### PRIOR ART DOCUMENTS

### Patent Documents

Patent Document 1: JP-A-11-961
Patent Document 2: JP-A-2001-64607
Patent Document 3: JP-A-2001-131512
Patent Document 4: JP-A-2003-27026
Patent Document 5: Japanese Patent No. 3810490
Patent Document 6: JP-A-09-165460

### SUMMARY OF THE INVENTION

### Problems to be Solved by the Invention

As mentioned above, none of the conventional techniques can solve the problems in a well-balanced manner. In electronics related technical fields where static build-up or staining is a particularly serious problem, the conventional techniques hardly address demands for further improvement of surface protecting films with antistatic properties and other properties. There is no water-dispersible acrylic pressure-sensitive adhesive with removability available at present.

It is therefore an object of the present invention to provide a water-dispersible acrylic pressure-sensitive adhesive composition capable of forming a pressure-sensitive adhesive layer that is superior not only in antistatic properties, adhesive properties, removability, removal stability, and the ability to prevent an increase in adhesive strength over time, but also in less-staining properties on adherends, appearance characteristics (with reduced appearance defects such as dents), and especially, the ability to prevent white staining on adherends in a high-humidity environment (the ability to prevent white staining). It is another object of the present invention to provide a pressure-sensitive adhesive sheet having a pressure-sensitive adhesive layer made from such a pressure-sensitive adhesive composition.

### Means for Solving the Problems

As a result of earnest study to achieve the objects, the inventors have completed the present invention based on findings that a removable water-dispersible acrylic pressure-sensitive adhesive composition obtained using, as components, a specific acrylic emulsion polymer obtained from raw material monomers with a specific composition, an ionic compound, and an antifoamer (release aid) having a specific structure can form a pressure-sensitive adhesive layer superior in antistatic properties, adhesive properties, removability, removal stability, the ability to prevent an increase in adhesive strength, less-staining properties, and appearance characteristics.

Specifically, the present invention is directed to a removable water-dispersible acrylic pressure-sensitive adhesive composition, including: an acrylic emulsion polymer including 70 to 99.5% by weight of a monomer unit derived from an alkyl(meth)acrylate and 0.5 to 10% by weight of a monomer unit derived from a carboxyl group-containing unsaturated monomer; an ionic compound; and a polyether antifoamer represented by formula (I) below.

HO—(PO)ₙ₁-(EO)ₘ₁—H (I)

In formula (I), PO represents an oxypropylene group, EO represents an oxyethylene group, m1 represents an integer of 0 to 40, n1 represents an integer of 1 or more, and EO and PO are added in a random form or a block form.

In the removable water-dispersible acrylic pressure-sensitive adhesive composition of the present invention, the ionic compound is preferably an ionic liquid and/or an alkali metal salt.

In the removable water-dispersible acrylic pressure-sensitive adhesive composition of the present invention, the ionic liquid is preferably a non-water-soluble ionic liquid and/or a water-soluble ionic liquid.

In the removable water-dispersible acrylic pressure-sensitive adhesive composition of the present invention, the ionic liquid preferably contains at least one selected from the group consisting of cations represented by formulae (A) to (E) below.

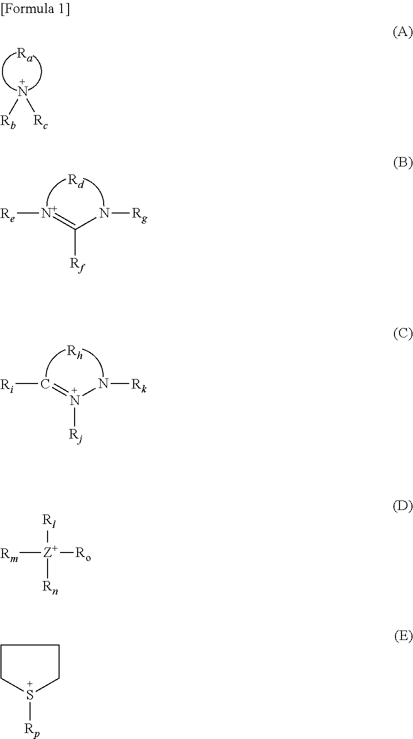

In formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent.

In formula (B), R_{d} represents a hydrocarbon group of 2 to 20 carbon atoms, part of the hydrocarbon group may be a heteroatom-substituted functional group, Rₑ, R_{f}, and R_{g} are the same or different and each represent hydrogen or a hydrocarbon group of 1 to 16 carbon atoms, and part of the hydrocarbon group may be a heteroatom-substituted functional group.

In formula (C), Rₕ represents a hydrocarbon group of 2 to 20 carbon atoms, part of the hydrocarbon group may be a heteroatom-substituted functional group, Rᵢ, Rⱼ, and Rₖ are the same or different and each represent hydrogen or a hydrocarbon group of 1 to 16 carbon atoms, and part of the hydrocarbon group may be a heteroatom-substituted functional group.

In formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent.

In formula (E), Rₚ represents a hydrocarbon group of 1 to 18 carbon atoms, and part of the hydrocarbon group may be a heteroatom-substituted functional group.

In the water-dispersible acrylic pressure-sensitive adhesive composition of the present invention, the cation of the ionic liquid is preferably of at least one selected from the group consisting of an imidazolium-containing salt type, a pyridinium-containing salt type, a morpholinium-containing salt type, a pyrrolidinium-containing salt type, and a piperidinium-containing salt type.

In the removable water-dispersible acrylic pressure-sensitive adhesive composition of the present invention, the ionic liquid preferably contains one or more of cations represented by formulae (a) to (d) below.

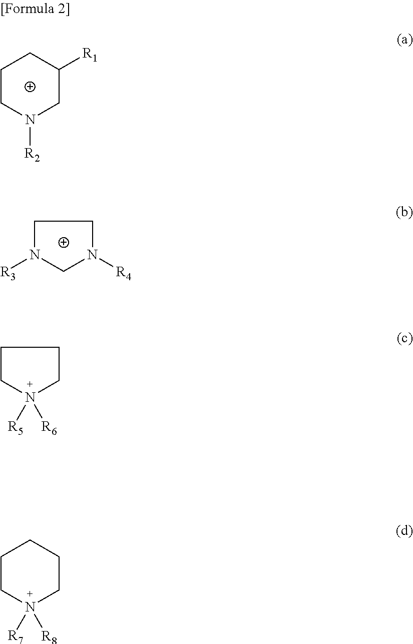

In formula (a), R₁ represents hydrogen or a hydrocarbon group of 1 to 3 carbon atoms, and R₂ represents hydrogen or a hydrocarbon group of 1 to 5 carbon atoms.

In formula (b), R₃ represents hydrogen or a hydrocarbon group of 1 to 3 carbon atoms, and R₄ represents hydrogen or a hydrocarbon group of 1 to 5 carbon atoms.

In formula (c), R₅ represents hydrogen or a hydrocarbon group of 1 to 3 carbon atoms, and R₆ represents hydrogen or a hydrocarbon group of 1 to 5 carbon atoms.

In formula (d), R₇ represents hydrogen or a hydrocarbon group of 1 to 3 carbon atoms, and R₈ represents hydrogen or a hydrocarbon group of 1 to 5 carbon atoms.

In the removable water-dispersible acrylic pressure-sensitive adhesive composition of the present invention, the ionic liquid preferably contains a fluorine atom-containing anion.

In the removable water-dispersible acrylic pressure-sensitive adhesive composition of the present invention, the ionic liquid preferably contains a fluoroalkyl group-containing anion.

In the removable water-dispersible acrylic pressure-sensitive adhesive composition of the present invention, the ionic liquid preferably contains an imide group-containing anion.

The removable water-dispersible acrylic pressure-sensitive adhesive composition of the present invention preferably contains 10 parts by weight or less of the ionic liquid based on 100 parts by weight of the solid of the acrylic emulsion polymer.

In the removable water-dispersible acrylic pressure-sensitive adhesive composition of the present invention, the alkali metal salt preferably contains a fluorine-containing anion.

In the removable water-dispersible acrylic pressure-sensitive adhesive composition of the present invention, the alkali metal salt is preferably a lithium salt.

The removable water-dispersible acrylic pressure-sensitive adhesive composition of the present invention preferably contains 5 parts by weight or less of the alkali metal salt based on 100 parts by weight of the solid of the acrylic emulsion polymer.

In the removable water-dispersible acrylic pressure-sensitive adhesive composition of the present invention, the polyether antifoamer is preferably represented by formula (II) below.

HO—(PO)ₐ-(EO)_{b}—(PO)_{c}—H (II)

In formula (II), PO represents an oxypropylene group, EO represents an oxyethylene group, and a to c each represent an integer of 1 or more.

In the removable water-dispersible acrylic pressure-sensitive adhesive composition of the present invention, the polyether antifoamer preferably has an oxypropylene content of 50 to 95% by weight.

In the removable water-dispersible acrylic pressure-sensitive adhesive composition of the present invention, the polyether antifoamer preferably has a number average molecular weight of 1,200 to 4,000.

The removable water-dispersible acrylic pressure-sensitive adhesive composition of the present invention preferably contains 10 parts by weight or less of the polyether antifoamer based on 100 parts by weight of the solid of the acrylic emulsion polymer.

In the removable water-dispersible acrylic pressure-sensitive adhesive composition of the present invention, the acrylic emulsion polymer is preferably a product of polymerization with a reactive emulsifier containing a radically-polymerizable functional group in its molecule.

The removable water-dispersible acrylic pressure-sensitive adhesive composition of the present invention preferably further includes a non-water-soluble crosslinking agent having two or more functional groups per molecule, wherein the functional groups are capable of reacting with a carboxyl group.

The present invention is also directed to a pressure-sensitive adhesive sheet, including: a substrate; and a pressure-sensitive adhesive layer formed on at least one side of the substrate and made from the removable water-dispersible acrylic pressure-sensitive adhesive composition.

The pressure-sensitive adhesive sheet of the present invention is preferably a surface protecting film for use on an optical member.

The present invention is also directed to an optical member including the pressure-sensitive adhesive sheet as a bonded component.

### Effect of the Invention

The removable water-dispersible acrylic pressure-sensitive adhesive composition of the present invention, which contains a specific acrylic emulsion polymer, an ionic compound, and a polyether antifoamer having the specified structure, can be used for removable applications and can form a pressure-sensitive adhesive layer superior in antistatic properties, adhesive properties (adhesion), removability (light peelability), removal stability, and the ability to prevent an increase in adhesive strength (peel strength) to an adherend over time. Such a pressure-sensitive adhesive layer is also superior in appearance characteristics with reduced appearance defects such as dents, less-staining properties on adherends, and the ability to prevent white staining during storage in a high-humidity environment. Thus, the removable water-dispersible acrylic pressure-sensitive adhesive composition of the present invention is particularly useful in applications to protect the surface of optical films and other products. When used in the surface protecting applications, the pressure-sensitive adhesive sheet bonded to an optical member as an adherend can be peeled off from the optical member with no adhesive residue, and such an optical member is useful.

### BRIEF DESCRIPTION OF THE DRAWING

FIG. 1 is a schematic diagram of an electrical potential measuring unit.

### MODE FOR CARRYING OUT THE INVENTION

The removable water-dispersible acrylic pressure-sensitive adhesive composition (also simply referred to as the “pressure-sensitive adhesive composition”) of the present invention contains an acrylic emulsion polymer including 70 to 99.5% by weight of a monomer unit derived from an alkyl(meth)acrylate and 0.5 to 10% by weight of a monomer unit derived from a carboxyl group-containing unsaturated monomer; an ionic compound; and a polyether antifoamer represented by formula (I) below.

HO—(PO)ₙ₁(EO)ₘ₁—H (I)

In formula (I), PO represents an oxypropylene group, EO represents an oxyethylene group, m1 represents an integer of 0 to 40, n1 represents an integer of 1 or more, and EO and PO are added in a random form or a block form.

As regards the pressure-sensitive adhesive composition of the present invention, the term “water-dispersible” refers to the ability to be dispersed in an aqueous medium, in other words, means that the pressure-sensitive adhesive composition is dispersible in an aqueous medium. The aqueous medium is a medium (dispersion medium) containing water as an essential component. The aqueous medium may be water alone or a mixture of water and a water-soluble organic solvent. Herein, the pressure-sensitive adhesive composition of the present invention may also be a dispersion containing the aqueous medium.

### [Acrylic Emulsion Polymer]

The acrylic emulsion polymer is a polymer made from raw material monomers including 70 to 99.5% by weight of a monomer unit derived from an alkyl(meth)acrylate and 0.5 to 10% by weight of a monomer unit derived from a carboxyl group-containing unsaturated monomer. One acrylic emulsion polymer may be used alone, or two or more acrylic emulsion polymers may be used in combination. As used herein, the term “(meth)acrylate” refers to acrylate and/or methacrylate.

The alkyl(meth)acrylate, which is used as a principal monomer, plays a role to produce basic properties for the pressure-sensitive adhesive (or pressure-sensitive adhesive layer), such as adhesion and peelability. In particular, alkyl acrylates tend to impart flexibility to the polymer used to form the pressure-sensitive adhesive layer and tend to produce the effect of allowing the pressure-sensitive adhesive layer to have tackiness and adhesive properties. Alkyl methacrylates tend to impart hardness to the polymer used to form the pressure-sensitive adhesive layer and tend to produce the effect of controlling the removability of the pressure-sensitive adhesive layer. The alkyl(meth)acrylate may be, but not limited to, an alkyl(meth)acrylate having a linear, branched, or cyclic alkyl group of 2 to 16 carbon atoms (more preferably 2 to 10 carbon atoms, even more preferably 4 to 8 carbon atoms).

For example, the alkyl acrylate is preferably an alkyl acrylate having an alkyl group of 2 to 14 carbon atoms (more preferably 4 to 9 carbon atoms), examples of which include n-butyl acrylate, isobutyl acrylate, sec-butyl acrylate, isoamyl acrylate, hexyl acrylate, heptyl acrylate, octyl acrylate, 2-ethylhexyl acrylate, isooctyl acrylate, nonyl acrylate, isononyl acrylate, and other alkyl acrylates having a linear or branched alkyl group. In particular, 2-ethylhexyl acrylate is preferred.

For example, the alkyl methacrylate is preferably an alkyl methacrylate having an alkyl group of 2 to 16 carbon atoms (more preferably 2 to 10 carbon atoms), examples of which include ethyl methacrylate, propyl methacrylate, isopropyl methacrylate, n-butyl methacrylate, isobutyl methacrylate, sec-butyl methacrylate, tert-butyl methacrylate, and other alkyl methacrylates having a linear or branched alkyl group; and cyclic alkyl methacrylates such as cyclohexyl methacrylate, bornyl methacrylate, and isobornyl methacrylate.

These alkyl(meth)acrylates may be appropriately selected depending on the desired adhesive properties and other properties and may be used singly or in combination of two or more.

The content of the alkyl(meth)acrylate(s) is from 70 to 99.5% by weight, preferably from 85 to 98% by weight, more preferably from 87 to 96% by weight, based on the total amount of the raw material monomers (all the raw material monomers (100% by weight)) used to form the acrylic emulsion polymer according to the invention. An alkyl(meth)acrylate content of 70% by weight or more is preferable in that the pressure-sensitive adhesive layer can have improved adhesion or removability. On the other hand, if the alkyl(meth)acrylate content is more than 99.5% by weight, the carboxyl group-containing unsaturated monomer content will be relatively low, so that the pressure-sensitive adhesive composition can form a pressure-sensitive adhesive layer with an undesirable appearance. When two or more alkyl(meth)acrylates are used, the total content (total amount) of all the alkyl(meth)acrylates should fall within the range.

The carboxyl group-containing unsaturated monomer can form a protective layer at the surface of emulsion particles including the acrylic emulsion polymer according to the invention and can function to prevent shear failure of the particles. This effect can be further improved by neutralizing the carboxyl group with a base. The stability of the particles against shear failure is more generally called mechanical stability. When used in combination with one or more crosslinking agents (preferably non-water-soluble crosslinking agents in the invention) reactive with the carboxyl group, the carboxyl group-containing unsaturated monomer can act as a crosslink point at a stage where the pressure-sensitive adhesive layer is formed through removal of water. The carboxyl group-containing unsaturated monomer can also improve the tackiness (anchoring properties) to a substrate through a crosslinking agent (non-water-soluble crosslinking agent). Examples of such a carboxyl group-containing unsaturated monomer include (meth)acrylic acid (acrylic acid and/or methacrylic acid), itaconic acid, maleic acid, fumaric acid, crotonic acid, carboxyethyl acrylate, and carboxypentyl acrylate. The term “carboxyl group-containing unsaturated monomer” is also intended to include acid anhydride group-containing unsaturated monomers such as maleic anhydride and itaconic anhydride. In particular, acrylic acid is preferred because it can have a relatively high concentration at the particle surface and can easily form a protective layer with a higher density.

The content of the carboxyl group-containing unsaturated monomer is from 0.5 to 10% by weight, preferably from 1 to 5% by weight, more preferably from 2 to 4% by weight, based on the total amount of the raw material monomers (all the raw material monomers (100% by weight)) used to form the acrylic emulsion polymer according to the present invention. When the content is 10% by weight or less, an increase in the interaction between a pressure-sensitive adhesive layer and functional groups present on the surface of an adherend (the object to be protected) such as a polarizing plate can be suppressed after the pressure-sensitive adhesive layer is formed, so that an increase in adhesive strength over time can be suppressed and peelability can be improved, which is preferred. If the content is more than 10% by weight, the carboxyl group-containing unsaturated monomer (such as acrylic acid), which is generally soluble in water, may be polymerized in water to cause thickening (an increase in viscosity). It is conceivable that if a large number of carboxyl groups are present in the skeleton of the acrylic emulsion polymer, the carboxyl groups can interact with the ionic compound (such as a non-water-soluble (hydrophobic) ionic liquid, a water-soluble ionic liquid, or an alkali metal salt), which is added as an antistatic agent, so that ion conduction can be hindered and antistatic performance for the adherend may fail to be obtained, which is not preferred. On the other hand, when the content is 0.5% by weight or more, the emulsion particles can have higher mechanical stability, which is preferred. In this case, tackiness (anchoring properties) between the pressure-sensitive adhesive layer and the substrate can also increase, so that adhesive residues can be suppressed, which is preferred.

To impart a specific function, other raw material monomers may also be used in combination with the above essential components (the alkyl(meth)acrylate and the carboxyl group-containing unsaturated monomer) to form the acrylic emulsion polymer according to the present invention. Examples of such monomers include methyl methacrylate, vinyl acetate, diethylacrylamide, and the like, which may be used to reduce appearance defects. When any of these monomers are used, the emulsion particles can have higher stability, so that a gel (aggregate) can be reduced. When a non-water-soluble crosslinking agent is used, the use of any of these monomers makes it possible to increase the affinity for the hydrophobic non-water-soluble crosslinking agent, so that the emulsion particles can have higher dispersibility and poor dispersion-induced dents on the pressure-sensitive adhesive layer can be reduced. Epoxy group-containing monomers such as glycidyl(meth)acrylate and polyfunctional monomers such as trimethylolpropane tri(meth)acrylate and divinylbenzene may also be used for the purposes of crosslinking the interior of the emulsion particles and increasing the cohesive strength. These monomers are each preferably mixed (added) at a content of less than 5% by weight. Herein, this content (amount) is based on the total amount of the raw material monomers (all the raw material monomers (100% by weight)) used to form the acrylic emulsion polymer according to the present invention.

To further reduce white staining, it is preferable to reduce the content (amount) of a hydroxyl group-containing unsaturated monomer such as 2-hydroxyethyl acrylate or 2-hydroxypropyl acrylate as one of the other monomers mentioned above. Specifically, the content of a hydroxyl group-containing unsaturated monomer in the raw material monomers (all the raw material monomers (100% by weight)) used to form the acrylic emulsion polymer according to the present invention is preferably less than 1% by weight, more preferably less than 0.1% by weight, even more preferably substantially 0% by weight (typically, less than 0.05% by weight). In some cases, however, it is necessary to introduce a crosslink point, such as crosslink between a hydroxyl group and an isocyanate group or metal crosslink. In such cases, a hydroxyl group-containing unsaturated monomer may be added (used) in an amount of about 0.01 to about 10% by weight.

The acrylic emulsion polymer according to the invention can be obtained by subjecting the raw material monomers (monomer mixture) to emulsion polymerization in the presence of an emulsifier and a polymerization initiator.

### [Reactive Emulsifier]

An emulsifier may be used in the emulsion polymerization for producing the acrylic emulsion polymer according to the invention. The emulsifier is preferably a reactive emulsifier having a radically-polymerizable functional group introduced in the molecule (radically-polymerizable functional group-containing reactive emulsifier). Such emulsifiers may be used alone or in combination of two or more.

The radically-polymerizable functional group-containing reactive emulsifier (hereinafter, referred to as the “reactive emulsifier”) has at least one radically-polymerizable functional group in the molecule (per molecule). The reactive emulsifier may be, but not limited to, one or more selected from a variety of reactive emulsifiers having a radically-polymerizable functional group such as a vinyl group, a propenyl group, an isopropenyl group, a vinyl ether group (vinyloxy group), or an allyl ether group (allyloxy group). The reactive emulsifier is preferably used because the emulsifier can be incorporated into the polymer so that staining caused by the emulsifier can be reduced.

For example, the reactive emulsifier may have a structure obtained by introducing a radially-polymerizable functional group (radially reactive group) such as a propenyl group or an allyl ether group into a nonionic-anionic emulsifier (a nonionic hydrophilic group-containing anionic emulsifier) such as sodium polyoxyethylene alkyl ether sulfate, ammonium polyoxyethylene alkyl phenyl ether sulfate, sodium polyoxyethylene alkyl phenyl ether sulfate, or sodium polyoxyethylene alkyl sulfosuccinate (or may correspond to such a structure). Hereinafter, the reactive emulsifier having a structure obtained by introducing a radically-polymerizable functional group into an anionic emulsifier will be called the “anionic reactive emulsifier.” The reactive emulsifier having a structure obtained by introducing a radically-polymerizable functional group into a nonionic-anionic emulsifier will be called the “nonionic-anionic reactive emulsifier.”

Particularly when the anionic reactive emulsifier (especially, the nonionic-anionic reactive emulsifier) is used, the emulsifier can improve the less-staining properties by being incorporated into the polymer. Also, particularly when the non-water-soluble crosslinking agent according to the present invention is a polyfunctional epoxy crosslinking agent having an epoxy group, the catalytic action of the reactive emulsifier can increase the reactivity of the crosslinking agent. If the anionic reactive emulsifier is not used, a crosslinking reaction may fail to stop at the stage of aging so that the problem of a change in the adhesive strength of the pressure-sensitive adhesive layer over time may occur. The anionic reactive emulsifier is preferred because it can be incorporated into the polymer and thus prevented from precipitating on the surface of an adherend, so that it will not cause white staining, in contrast to a quaternary ammonium compound (see, for example, JP-A-2007-31585) commonly used as a catalyst for epoxy crosslinking agents, which can precipitate on an adherend.

Such a reactive emulsifier may be a commercially available product such as ADEKA REASOAP SE-10N (trade name) manufactured by ADEKA CORPORATION, AQUALON HS-10 (trade name) manufactured by DAI-ICHI KOGYO SEIYAKU CO., LTD., and AQUALON HS-05 (trade name) manufactured by DAI-ICHI KOGYO SEIYAKU CO., LTD., and AQUALON HS-1025 (trade name) manufactured by DAI-ICHI KOGYO SEIYAKU CO., LTD.

In particular, impurity ions may cause a problem. Therefore, impurity ions should be removed, and the emulsifier to be used should preferably have an SO₄²⁻ ion concentration of 100 μg/g or less. In the case of the anionic emulsifier, an ammonium salt emulsifier is preferably used. Impurities can be removed from the emulsifier using an ion-exchange resin method, a membrane separation method, an impurity precipitation and filtration method with alcohol, or other appropriate methods.

Based on 100 parts by weight of the total amount of the raw material monomers (all the raw material monomers) used to form the acrylic emulsion polymer according to the present invention, the content (amount) of the reactive emulsifier is preferably from 0.1 to 10 parts by weight, more preferably from 0.5 to 8 parts by weight, even more preferably from 0.5 to 7 parts by weight, further more preferably from 0.5 to 6 parts by weight, still more preferably from 0.6 to 7 parts by weight, most preferably from 1 to 4.5 parts by weight. A reactive emulsifier content of 0.1 parts by weight or more is preferable in that stable emulsion can be maintained. On the other hand, a reactive emulsifier content of 10 parts by weight or less is preferable in that the pressure-sensitive adhesive (pressure-sensitive adhesive layer) can have higher cohesive strength, staining on the adherend can be suppressed, and the emulsifier can be prevented from causing staining.

A polymerization initiator may be used in emulsion polymerization to form the acrylic emulsion polymer. Examples of such a polymerization initiator include, but are not limited to, azo polymerization initiators such as 2,2′-azobisisobutyronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, and 2,2′-azobis(N,N′-dimethyleneisobutylamidine); persulfates such as potassium persulfate and ammonium persulfate; peroxide polymerization initiators such as benzoyl peroxide and tert-butyl hydroperoxide; and a redox system polymerization initiator including a combination of a peroxide and a reducing agent, such as a combination of a peroxide and ascorbic acid (e.g., a combination of hydrogen peroxide water and ascorbic acid), a combination of a peroxide and an iron (II) salt (e.g., a combination of hydrogen peroxide water and an iron (II) salt), and a combination of a persulfate and sodium hydrogen sulfite.

The amount of addition (use) of the polymerization initiator, which may be appropriately determined depending on the type of the initiator or the raw material monomers, is preferably, but not limited to, 0.01 to 1 part by weight, more preferably 0.02 to 0.5 parts by weight, based on 100 parts by weight of the total amount of the raw material monomers (all the raw material monomers) used to form the acrylic emulsion polymer according to the invention.

The emulsion polymerization for the acrylic emulsion polymer according to the invention may be performed using a conventional method including emulsifying the monomers in water and then subjecting the emulsion to emulation polymerization. This method prepares an aqueous dispersion (polymer emulsion) containing the acrylic emulsion polymer as a base polymer. The emulsion polymerization method may be any known emulsion polymerization method such as a batch mixing method (batch polymerization method), a monomer dropping method, or a monomer emulsion dropping method. In a monomer dropping method or a monomer emulsion dropping method, continuous dropping or intermittent dropping is appropriately selected. These methods may be combined as needed. Reaction conditions and other conditions are appropriately selected, in which, for example, the polymerization temperature is preferably from about 40 to about 95° C., and the polymerization time is preferably from about 30 minutes to about 24 hours.

In the present invention, the acrylic emulsion polymer preferably has a weight average molecular weight (Mw) of 40,000 to 200,000, more preferably 50,000 to 150,000, even more preferably 60,000 to 100,000. When the acrylic emulsion polymer has a weight average molecular weight of 40,000 or more, the pressure-sensitive adhesive composition can have higher wettability on the adherend and higher adhesion to the adherend. When the acrylic emulsion polymer has a weight average molecular weight of 200,000 or less, it is possible to reduce the amount of any residue (adhesive residue) of the pressure-sensitive adhesive composition potentially remaining on the adherend, so that the less-staining properties to the adherend can be improved. The pressure-sensitive adhesive obtained by emulsion polymerization is preferred because the polymerization mechanism allows the pressure-sensitive adhesive to have a very high molecular weight. It should be noted that the pressure-sensitive adhesive obtained by emulsion polymerization usually has a high gel content and cannot be subjected to gel permeation chromatography (GPC) measurement, which means that it is often difficult to identify the molecular weight by actual measurement.

In the present invention, the acrylic emulsion polymer preferably has a solvent-insoluble component content (a content of solvent-insoluble components, also referred to as a “gel fraction”) of 70% (% by weight) or more, more preferably 75% by weight or more, even more preferably 80% by weight or more, in view of less-staining properties or proper peel strength (adhesive strength). If the solvent-insoluble component content is less than 70% by weight, the acrylic emulsion polymer can contain a relatively large amount of low-molecular-weight components, so that only a crosslinking effect cannot sufficiently reduce the amount of low-molecular-weight components in the resulting pressure-sensitive adhesive layer. In this case, the low-molecular-weight components and so on may cause staining on an adherend and may make the peel strength (adhesive strength) too high. The solvent-insoluble component content can be controlled by selecting the polymerization initiator, the reaction temperature, the emulsifier, the type of the raw material monomers, or other conditions. The upper limit of the solvent-insoluble component content is typically, but not limited to, 99% by weight. Herein, in the present invention, the solvent-insoluble component content of the acrylic emulsion polymer is the value determined by the “method for determining the solvent-insoluble component content” described below.

### (Method for Determining the Solvent-Insoluble Component Content)

About 0.1 g of the acrylic emulsion polymer is sampled and then wrapped in a porous tetrafluoroethylene sheet (NTF1122 (trade name) manufactured by NITTO DENKO CORPORATION) with an average pore size of 0.2 μm. The sheet is then tied with a kite string. The weight of the resulting product is measured and called the weight before immersion. The weight before immersion is the total weight of the acrylic emulsion polymer (sampled as mentioned above), the tetrafluoroethylene sheet, and the kite string. The total weight of the tetrafluoroethylene sheet and the kite string is also measured and called the wrapping weight. The acrylic emulsion polymer wrapped in the tetrafluoroethylene sheet and tied with the kite string (referred to as the “sample”) is then placed in a 50 ml vessel filled with ethyl acetate and allowed to stand at 23° C. for 7 days. Subsequently, the sample is taken out of the vessel (after the treatment with ethyl acetate) and transferred into an aluminum cup. The sample is dried in a dryer at 130° C. for 2 hours so that the ethyl acetate is removed. The weight of the sample is then measured and called the weight after immersion. The solvent-insoluble component content is calculated from the following formula.

Solvent-insoluble component content (% by weight)={(a−b)/(c−b)}×100 (1). In formula (1), a is the weight after immersion, b is the wrapping weight, and c is the weight before immersion.

The solvent-soluble component (also called “sol component”) of the acrylic emulsion polymer according to the invention preferably has a weight average molecular weight (Mw) of 40,000 to 200,000, more preferably 50,000 to 150,000, even more preferably 60,000 to 100,000. When the solvent-soluble component of the acrylic emulsion polymer has a weight average molecular weight of 40,000 or more, the pressure-sensitive adhesive composition can have higher wettability on the adherend and higher adhesion to the adherend. When the solvent-soluble component of the acrylic emulsion polymer has a weight average molecular weight of 200,000 or less, it is possible to reduce the amount of any residue of the pressure-sensitive adhesive composition potentially remaining on the adherend, so that the less-staining properties to the adherend can be improved. The weight average molecular weight of the solvent-soluble component of the acrylic emulsion polymer can be determined by the following process. The treatment liquid (the ethyl acetate solution) obtained after the treatment with ethyl acetate in the measurement of the solvent-insoluble component content of the acrylic emulsion polymerization is air-dried at room temperature. The resulting sample (the solvent-soluble component of the acrylic emulsion polymer) is subjected to gel permeation chromatography (GPC). More specifically, the following measurement method may be used.

More specifically, the following method may be used to determine the weight average molecular weight by the gel permeation chromatography (GPC).

### [Measurement Method]

The GPC measurement is performed using a GPC system HLC-8220GPC manufactured by TOSOH CORPORATION to determine the polystyrene-equivalent molecular weight. The measurement conditions are as follows.

Sample concentration: 0.2% by weight (THF solution)

Sample injection volume: 10 μl

Eluent: THF

Flow rate: 0.6 ml/minute

Measurement temperature: 40° C.

Columns:

Sample columns: TSK guard column Super HZ-H×1+TSK gel Super HZM-H×2

Reference column: TSK gel Super H-RC×1

Detector: differential refractometer

The acrylic emulsion polymer may be appropriately crosslinked so that the water-dispersible acrylic pressure-sensitive adhesive composition of the present invention can form a pressure-sensitive adhesive layer or sheet with a higher level of heat resistance, weather resistance, and other properties. Examples of the crosslinking agent that may be used in the present invention include an isocyanate compound, an epoxy compound, a melamine resin, an aziridine derivative, and a metal chelate compound. In particular, an isocyanate compound or an epoxy compound is preferably used mainly to achieve a suitable level of cohesive strength. These compounds may be used singly or in combination of two or more. Although any specific crosslinking method is typically, but not limited to, the use of a non-water-soluble crosslinking agent is particularly preferred mainly in terms of obtaining a suitable level of cohesive strength.

### [Non-Water-Soluble Crosslinking Agent]

In particular, the invention preferably uses a non-water-soluble crosslinking agent. The non-water-soluble crosslinking agent should be a non-water-soluble compound having, in the molecule (per molecule), two or more (e.g., two to six) functional groups capable of reacting with carboxyl groups. The number of functional groups capable of reacting with carboxyl groups is preferably three to five per molecule. As the number of functional groups capable of reacting with carboxyl groups increases per molecule, the pressure-sensitive adhesive composition can be crosslinked more densely (in other words, the polymer used to form a pressure-sensitive adhesive layer can have a dense crosslinked structure). This makes it possible to prevent the pressure-sensitive adhesive layer from wet-spreading after it is formed. In addition, the polymer used to form the pressure-sensitive adhesive layer can be constrained, so that the functional groups (carboxyl groups) in the pressure-sensitive adhesive layer can be prevented from segregating to the surface of the adherend, which makes it possible to prevent the peel strength (adhesive strength) between the pressure-sensitive adhesive layer and the adherend from increasing over time. On the other hand, if the number of functional groups capable of reacting with carboxyl groups is too large or more than six per molecule, a gel may form.

In the non-water-soluble crosslinking agent according to the present invention, the functional group capable of reacting with carboxyl groups is typically, but not limited to, an epoxy group, an isocyanate group, a carbodiimide group, or the like. In particular, an epoxy group is preferred in view of reactivity. A glycidylamino group is more preferred because it is highly reactive so that it would hardly remain unreacted during the crosslinking reaction, be advantageous for less-staining properties, and be effective in preventing unreacted carboxyl groups in the pressure-sensitive adhesive layer from increasing, overtime, the adhesive strength between the pressure-sensitive adhesive layer and the adherend. Specifically, the non-water-soluble crosslinking agent according to the present invention is preferably an epoxy crosslinking agent having an epoxy group, more preferably, a crosslinking agent having a glycidylamino group (glycidylamino-containing crosslinking agent). Herein, when the non-water-soluble crosslinking agent according to the present invention is an epoxy crosslinking agent (especially, a glycidylamino-containing crosslinking agent), the number of epoxy groups (especially, glycidylamino groups) per molecule is preferably two or more (e.g., two to six), more preferably three to five.

In the present invention, the non-water-soluble crosslinking agent is a compound insoluble in water. Herein, the term “non-water-soluble” means that the solubility in 100 parts by weight of water at 25° C. (the weight of the compound (crosslinking agent) soluble in 100 parts by weight of water) is 5 parts by weight or less, preferably 3 parts by weight or less, more preferably 2 parts by weight or less. When the non-water-soluble crosslinking agent is used, any residue of the crosslinking agent, not undergoing crosslinking, hardly causes white staining on the adherend in a high-humidity environment, so that the less-staining properties can be improved. If a water-soluble crosslinking agent is used, any residue of the crosslinking agent can dissolve in water and easily transfer onto the adherend in a high-humidity environment, so that it can easily cause white staining. As compared with water-soluble crosslinking agents, the non-water-soluble crosslinking agent can highly contribute to the crosslinking reaction (the reaction with carboxyl groups) and be highly effective in preventing the increase in adhesive strength over time. In addition, the non-water-soluble crosslinking agent, which is highly reactive for the crosslinking reaction, can rapidly undergo the crosslinking reaction during aging, so that unreacted carboxyl groups in the pressure-sensitive adhesive layer can be prevented from increasing the adhesive strength between the pressure-sensitive adhesive layer and the adherend over time.

For example, the solubility of the crosslinking agent in water can be determined as follows.

### [Method for Determining the Solubility in Water]

The same weights of water (25° C.) and the crosslinking agent are mixed using a mixer under the conditions of a rotation speed of 300 rmp and 10 minutes. The mixture is then separated into water and oil phases by centrifugation. The water phase is then collected and dried at 120° C. for 1 hour. The amount of the non-volatile component in the water phase (the parts by weight of the non-volatile component based on 100 parts by weight of water) is determined from the weight loss on drying.

Examples of the non-water-soluble crosslinking agent for the invention include glycidylamino-containing crosslinking agents such as 1,3-bis(N,N-diglycidylaminomethyl)cyclohexane (such as TETRAD-C (trade name) manufactured by MITSUBISHI GAS CHEMICAL COMPANY, INC. (with a solubility of 2 parts by weight or less in 100 parts by weight of water at 25° C.)) and 1,3-bis(N,N-diglycidylaminomethyl)benzene (such as TETRAD-X (trade name) manufactured by MITSUBISHI GAS CHEMICAL COMPANY, INC. (with a solubility of 2 parts by weight or less in 100 parts by weight of water at 25° C.)); and other epoxy crosslinking agents such as tris(2,3-epoxypropyl)isocyanurate (such as TEPIC-G (trade name) manufactured by NISSAN CHEMICAL INDUSTRIES, INC. (with a solubility of 2 parts by weight or less in 100 parts by weight of water at 25° C.)).

In the present invention, the content of the non-water-soluble crosslinking agent (the content of the non-water-soluble crosslinking agent in the pressure-sensitive adhesive composition of the present invention) is preferably such that the number of moles of the functional group of the non-water-soluble crosslinking agent, wherein the functional group is capable of reacting with a carboxyl group, is from 0.2 to 1.3 moles per mole of the carboxyl group of the carboxyl group-containing unsaturated monomer used as a raw material monomer to form the acrylic emulsion polymer according to the present invention. In other words, the ratio of the total number of moles of the functional groups of the non-water-soluble crosslinking agent, wherein the functional groups are capable of reacting with the carboxyl group, to the total number of moles of the carboxyl groups of all the carboxyl group-containing unsaturated monomers used as raw material monomers to form the acrylic emulsion polymer in the present invention (the molar ratio of the functional groups capable of reacting with the carboxyl groups to the carboxyl groups) is preferably from 0.2 to 1.3, more preferably from 0.3 to 1.1, even more preferably from 0.4 to 1.1, further more preferably from 0.5 to 1.0. A molar ratio of (the functional groups capable of reacting with the carboxyl groups)/(the carboxyl groups) of 0.2 or more is advantageous in that the amount of unreacted carboxyl groups in the pressure-sensitive adhesive layer can be reduced and that an increase in adhesive strength over time, which is caused by the interaction between the carboxyl groups and the adherend, can be effectively prevented. Also, a molar ratio of (the functional groups capable of reacting with the carboxyl groups)/(the carboxyl groups) of 1.3 or less is advantageous in that the amount of the unreacted non-water-soluble crosslinking agent in the pressure-sensitive adhesive layer can be reduced and that the non-water-soluble crosslinking agent can be suppressed from causing an appearance defect so that appearance characteristics can be improved.

Particularly when the non-water-soluble crosslinking agent is an epoxy crosslinking agent in the invention, the molar ratio of (the epoxy group)/(the carboxyl group) is preferably from 0.2 to 1.3, more preferably from 0.4 to 1.1, even more preferably from 0.5 to 1.0. Also when the non-water-soluble crosslinking agent is a glycidylamino-containing crosslinking agent, the molar ratio of (the glycidylamino group)/(the carboxyl group) preferably falls within the above range.

For example, when 4 g of a non-water-soluble crosslinking agent with a functional group equivalent of 110 (g/eq), wherein the functional group is capable of reacting with a carboxyl group, is added to (or mixed into) the removable water-dispersible acrylic pressure-sensitive adhesive composition (the pressure-sensitive adhesive composition), the number of moles of the functional group of the non-water-soluble crosslinking agent, capable of reacting with the carboxyl group, can be typically calculated as follows.

The number of moles of the functional group of the non-water-soluble crosslinking agent, capable of reacting with the carboxyl group, =[the added amount of the non-water-soluble crosslinking agent (the added amount)]/[the functional group equivalent]=4/110

For example, when 4 g of an epoxy crosslinking agent with an epoxy equivalent of 110 (g/eq) is added(mixed) as the non-water-soluble crosslinking agent, the number of moles of the epoxy group of the epoxy crosslinking agent can be typically calculated as follows.

The number of moles of the epoxy group of the epoxy crosslinking agent=[the added amount of the epoxy crosslinking agent (the added amount)]/[the epoxy equivalent]=4/110

The water-dispersible acrylic pressure-sensitive adhesive composition of the present invention may also contain a crosslinking agent other than the non-water-soluble crosslinking agent (another crosslinking agent). This crosslinking agent is preferably, but not limited to, a polyfunctional hydrazide crosslinking agent. When a polyfunctional hydrazide crosslinking agent is used, the pressure-sensitive adhesive composition can form a pressure-sensitive adhesive layer with an improved level of removability, adhesive properties (adhesion), and anchoring properties to a substrate (support). The polyfunctional hydrazide crosslinking agent (also simply referred to as “hydrazide crosslinking agent”) is a compound having at least two hydrazide groups in the molecule (per molecule). The number of hydrazide groups per molecule is preferably two or three, more preferably two. Preferred examples of such a compound for use as the hydrazide crosslinking agent include, but are not limited to, oxalic acid dihydrazide, malonic acid dihydrazide, succinic acid dihydrazide, glutaric acid dihydrazide, adipic acid dihydrazide, pimelic acid dihydrazide, suberic acid dihydrazide, azelaic acid dihydrazide, sebacic acid dihydrazide, dodecanedioic acid dihydrazide, phthalic acid dihydrazide, isophthalic acid dihydrazide, terephthalic acid dihydrazide, 2,6-naphthalenedicarboxylic acid dihydrazide, naphthalic acid dihydrazide, acetonedicarboxylic acid dihydrazide, fumaric acid dihydrazide, maleic acid dihydrazide, itaconic acid dihydrazide, trimellitic acid dihydrazide, 1,3,5-benzenetricarboxylic acid dihydrazide, pyromellitic acid dihydrazide, aconitic acid dihydrazide, and other dihydrazide compounds. In particular, adipic acid dihydrazide and sebacic acid dihydrazide are particularly preferred. These hydrazide crosslinking agents may be used singly or in combination of two or more.

A commercially available product may also be used as the hydrazide crosslinking agent. Examples of such a commercially available product include adipic acid dihydrazide (reagent grade) manufactured by Tokyo Chemical Industry Co., Ltd., adipoyl dihydrazide (reagent grade) manufactured by Wako Pure Chemical Industries, Ltd., etc.

The content of the hydrazide crosslinking agent (the content of the hydrazide crosslinking agent in the water-dispersible acrylic pressure-sensitive adhesive composition of the present invention) is preferably from 0.025 to 2.5 moles, more preferably from 0.1 to 2 moles, even more preferably from 0.2 to 1.5 moles, per mole of the keto group of a keto group-containing unsaturated monomer used as a raw material monomer for the acrylic emulsion polymer. If the content is less than 0.025 moles, the effect of adding the crosslinking agent may be small, so that the pressure-sensitive adhesive layer or sheet may be tough to peel off and low-molecular-weight components may remain in the polymer of the pressure-sensitive adhesive layer to easily cause white staining on an adherend. If the content is more than 2.5 moles, unreacted part of the crosslinking agent may cause staining in some cases.

### [Ionic Compound]

The removable water-dispersible acrylic pressure-sensitive adhesive composition of the present invention contains an ionic compound as an essential component. The ionic compound to be used is, for example, an ionic liquid or an alkali metal salt. The ionic liquid may be a non-water-soluble (hydrophobic) ionic liquid or a water-soluble ionic liquid. When the resulting pressure-sensitive adhesive layer (pressure-sensitive adhesive sheet) is attached to a non-antistatic adherend (the object to be protected) and then peeled off, the ionic compound contained in the composition can impart antistatic properties to the non-antistatic adherend. The ionic compound is also expected to have good compatibility and well-balanced interaction with the acrylic emulsion polymer.

### [Non-Water-Soluble (Hydrophobic) Ionic Liquid]

As used herein, the term “non-water-soluble (hydrophobic) ionic liquid” refers to a molten salt (ionic compound) that is in a liquid state at 25° C. and can separate and become clouded when an aqueous solution containing 10% by weight of it is prepared. The non-water-soluble (hydrophobic) ionic liquid is also simply referred to as the ionic liquid.

In addition, the non-water-soluble (hydrophobic) ionic liquid is preferably, but not limited to, a fluorine atom-containing compound, more preferably an imide salt. When the ionic liquid contains a fluorine atom, good antistatic properties can be provided, and when the ionic liquid is an imide salt, staining on the adherend can be suppressed, which is a preferred mode.

The non-water-soluble (hydrophobic) ionic liquid to be used is also preferably composed of an organic cation component represented by any one of formulae (A) to (E) below and an anion component, so that it can have high antistatic performance.

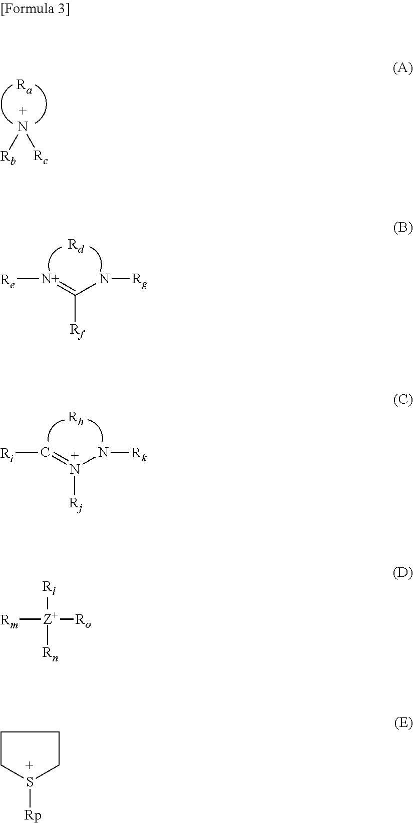

In formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent.

In formula (B), R_{d} represents a hydrocarbon group of 2 to 20 carbon atoms, part of the hydrocarbon group may be a heteroatom-substituted functional group, Rₑ, R_{f}, and R_{g} are the same or different and each represent hydrogen or a hydrocarbon group of 1 to 16 carbon atoms, and part of the hydrocarbon group may be a heteroatom-substituted functional group.

In formula (C), Rₕ represents a hydrocarbon group of 2 to 20 carbon atoms, part of the hydrocarbon group may be a heteroatom-substituted functional group, Rᵢ, Rⱼ, and Rₖ are the same or different and each represent hydrogen or a hydrocarbon group of 1 to 16 carbon atoms, and part of the hydrocarbon group may be a heteroatom-substituted functional group.

In formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent.

In formula (E), Rₚ represents a hydrocarbon group of 1 to 18 carbon atoms, and part of the hydrocarbon group may be a heteroatom-substituted functional group.

Examples of the cation of formula (A) include a pyridinium cation, a piperidinium cation, a pyrrolidinium cation, a pyrroline skeleton-containing cation, a pyrrole skeleton-containing cation, and a morpholinium cation.

Specific examples include a 1-ethylpyridinium cation, a 1-butylpyridinium cation, a 1-hexylpyridinium cation, a 1-butyl-3-methylpyridinium cation, a 1-butyl-4-methylpyridinium cation, a 1-hexyl-3-methylpyridinium cation, a 1-butyl-3,4-dimethylpyridinium cation, a 1,1-dimethylpyrrolidinium cation, a 1-ethyl-1-methylpyrrolidinium cation, a 1-methyl-1-propylpyrrolidinium cation, a 1-methyl-1-butylpyrrolidinium cation, a 1-methyl-1-pentylpyrrolidinium cation, a 1-methyl-1-hexylpyrrolidinium cation, a 1-methyl-1-heptylpyrrolidinium cation, a 1-ethyl-1-propylpyrrolidinium cation, a 1-ethyl-1-butylpyrrolidinium cation, a 1-ethyl-1-pentylpyrrolidinium cation, a 1-ethyl-1-hexylpyrrolidinium cation, a 1-ethyl-1-heptylpyrrolidinium cation, a 1,1-dipropylpyrrolidinium cation, a 1-propyl-1-butylpyrrolidinium cation, a 1,1-dibutylpyrrolidinium cation, a 1-propylpiperidinium cation, a 1-pentylpiperidinium cation, a 1,1-dimethylpiperidinium cation, a 1-methyl-1-ethylpiperidinium cation, a 1-methyl-1-propylpiperidinium cation, a 1-methyl-1-butylpiperidinium cation, a 1-methyl-1-pentylpiperidinium cation, a 1-methyl-1-hexylpiperidinium cation, a 1-methyl-1-heptylpiperidinium cation, a 1-ethyl-1-propylpiperidinium cation, a 1-ethyl-1-butylpiperidinium cation, a 1-ethyl-1-pentylpiperidinium cation, a 1-ethyl-1-hexylpiperidinium cation, a 1-ethyl-1-heptylpiperidinium cation, a 1,1-dipropylpiperidinium cation, a 1-propyl-1-butylpiperidinium cation, a 1,1-dibutylpiperidinium cation, a 2-methyl-1-pyrroline cation, a 1-ethyl-2-phenylindole cation, a 1,2-dimethylindole cation, a 1-ethylcarbazole cation, and an N-ethyl-N-methylmorpholinium cation.

Examples of the cation of formula (B) include an imidazolium cation, a tetrahydropyrimidinium cation, and a dihydropyrimidinium cation.

Specific examples include a 1,3-dimethylimidazolium cation, a 1,3-diethylimidazolium cation, a 1-ethyl-3-methylimidazolium cation, a 1-butyl-3-methylimidazolium cation, a 1-hexyl-3-methylimidazolium cation, a 1-ocytl-3-methylimidazolium cation, a 1-decyl-3-methylimidazolium cation, a 1-dodecyl-3-methylimidazolium cation, a 1-tetradecyl-3-methylimidazolium cation, a 1,2-dimethyl-3-propylimidazolium cation, a 1-ethyl-2,3-dimethylimidazolium cation, a 1-butyl-2,3-dimethylimidazolium cation, a 1-hexyl-2,3-dimethylimidazolium cation, a 1,3-dimethyl-1,4,5,6-tetrahydropyrimidinium cation, a 1,2,3-trimethyl-1,4,5,6-tetrahydropyrimidinium cation, a 1,2,3,4-tetramethyl-1,4,5,6-tetrahydropyrimidinium cation, a 1,2,3,5-tetramethyl-1,4,5,6-tetrahydropyrimidinium cation, a 1,3-dimethyl-1,4-dihydropyrimidinium cation, a 1,3-dimethyl-1,6-dihydropyrimidinium cation, a 1,2,3-trimethyl-1,4-dihydropyrimidinium cation, a 1,2,3-trimethyl-1,6-dihydropyrimidinium cation, a 1,2,3,4-tetramethyl-1,4-dihydropyrimidinium cation, and a 1,2,3,4-tetramethyl-1,6-dihydropyrimidinium cation.

Examples of the cation of formula (C) include a pyrazolium cation and a pyrazolinium cation.

Specific examples include a 1-methylpyrazolium cation, a 3-methylpyrazolium cation, a 1-ethyl-2-methylpyrazolinium cation, a 1-ethyl-2,3,5-trimethylpyrazolium cation, a 1-propyl-2,3,5-trimethylpyrazolium cation, a 1-butyl-2,3,5-trimethylpyrazolium cation, a 1-ethyl-2,3,5-trimethylpyrazolinium cation, a 1-propyl-2,3,5-trimethylpyrazolinium cation, and a 1-butyl-2,3,5-trimethylpyrazolinium cation.

Examples of the cation of formula (D) include a tetraalkylammonium cation, a trialkylsulfonium cation, a tetraalkylphosphonium cation, and derivatives thereof in which part of the alkyl group is replaced by an alkenyl group, an alkoxyl group, a hydroxyl group, a cyano group, or an epoxy group.

Specific examples include a tetramethylammonium cation, a tetraethylammonium cation, a tetrabutylammonium cation, a tetrapentylammonium cation, a tetrahexylammonium cation, a tetraheptylammonium cation, a triethylmethylammonium cation, a tributylethylammonium cation, an N,N-diethyl-N-methyl-N-(2-methoxyethyl)ammonium cation, a glycidyltrimethylammonium cation, a trimethylsulfonium cation, a triethylsulfonium cation, a tributylsulfonium cation, a trihexylsulfonium cation, a diethylmethylsulfonium cation, a dibutylethylsulfonium cation, a tetramethylphosphonium cation, a tetraethylphosphonium cation, a tetrabutylphosphonium cation, a tetrahexylphosphonium cation, a tetraoctylphosphonium cation, a triethylmethylphosphonium cation, a tributylethylphosphonium cation, and a diallyldimethylammonium cation. In particular, preferably used are unsymmetrical tetraalkylammonium cations such as a triethylmethylammonium cation, a tributylethylammonium cation, a diethylmethylsulfonium cation, a dibutylethylsulfonium cation, a triethylmethylphosphonium cation, a tributylethylphosphonium cation, and a trimethyldecylphosphonium cation, a trialkylsulfonium cation, a tetraalkylphosphonium cation, an N,N-diethyl-N-methyl-N-(2-methoxyethyl)ammonium cation, a glycidyltrimethylammonium cation, a diallyldimethylammonium cation, an N,N-dimethyl-N-ethyl-N-propylammonium cation, an N,N-dimethyl-N-ethyl-N-butylammonium cation, an N,N-dimethyl-N-ethyl-N-pentylammonium cation, an N,N-dimethyl-N-ethyl-N-hexylammonium cation, an N,N-dimethyl-N-ethyl-N-heptylammonium cation, an N,N-dimethyl-N-ethyl-N-nonylammonium cation, an N,N-dimethyl-N,N-dipropylammonium cation, an N,N-diethyl-N-propyl-N-butylammonium cation, an N,N-dimethyl-N-propyl-N-pentylammonium cation, an N,N-dimethyl-N-propyl-N-hexylammonium cation, an N,N-dimethyl-N-propyl-N-heptylammonium cation, an N,N-dimethyl-N-butyl-N-hexylammonium cation, an N,N-diethyl-N-butyl-N-heptylammonium cation, an N,N-dimethyl-N-pentyl-N-hexylammonium cation, an N,N-dimethyl-N,N-dihexylammonium cation, a trimethylheptylammonium cation, an N,N-diethyl-N-methyl-N-propylammonium cation, an N,N-diethyl-N-methyl-N-pentylammonium cation, an N,N-diethyl-N-methyl-N-heptylammonium cation, an N,N-diethyl-N-propyl-N-pentylammonium cation, a triethylpropylammonium cation, a triethylpentylammonium cation, a triethylheptylammonium cation, an N,N-dipropyl-N-methyl-N-ethylammonium cation, an N,N-dipropyl-N-methyl-N-pentylammonium cation, an N,N-dipropyl-N-butyl-N-hexylammonium cation, an N,N-dipropyl-N,N-dihexylammonium cation, an N,N-dibutyl-N-methyl-N-pentylammonium cation, an N,N-dibutyl-N-methyl-N-hexylammonium cation, a trioctylmethylammonium cation, and an N-methyl-N-ethyl-N-propyl-N-pentylammonium cation.

For example, the cation of formula (E) may be a sulfonium cation or the like. Examples of Rₚ in formula (E) include a methyl group, an ethyl group, a propyl group, a butyl group, a hexyl group, an octyl group, a nonyl group, a decyl group, a dodecyl group, a tridecyl group, a tetradecyl group, and an octadecyl group.

In the water-dispersible acrylic pressure-sensitive adhesive composition of the present invention, the cation of the ionic liquid is preferably of at least one selected from the group consisting of an imidazolium-containing salt type, a pyridinium-containing salt type, a morpholinium-containing salt type, a pyrrolidinium-containing salt type, a piperidinium-containing salt type, an ammonium-containing salt type, a phosphonium-containing salt type, and a sulfonium-containing salt type. Herein, these ionic liquids contain one of the cations of formulae (A), (B), and (D).

In the water-dispersible acrylic pressure-sensitive adhesive composition of the invention, the ionic liquid preferably contains at least one cation selected from the group consisting of cations represented by formulae (a) to (d) below. These cations are included in those of formulae (A) and (B).

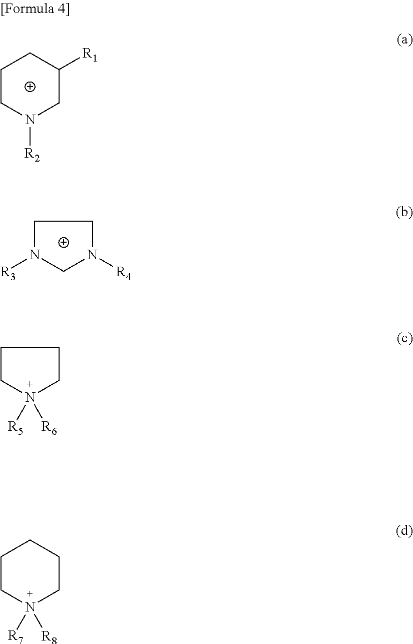

In formula (a), R₁ represents hydrogen or a hydrocarbon group of 1 to 3 carbon atoms, preferably hydrogen or a hydrocarbon group of one carbon atom, and R₂ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (b), R₃ represents hydrogen or a hydrocarbon group of 1 to 3 carbon atoms, preferably hydrogen or a hydrocarbon group of one carbon atom, and R₄ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (c), R₅ represents hydrogen or a hydrocarbon group of 1 to 3 carbon atoms, preferably hydrogen or a hydrocarbon group of one carbon atom, and R₆ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (d), R₇ represents hydrogen or a hydrocarbon group of 1 to 3 carbon atoms, preferably hydrogen or a hydrocarbon group of one carbon atom, and R₈ represents hydrogen or a hydrocarbon group of 1 to 7 carbon atoms, preferably a hydrocarbon group of 1 to 6 carbon atoms, more preferably a hydrocarbon group of 1 to 4 carbon atoms.

On the other hand, any anion component capable of forming the non-water-soluble (hydrophobic) ionic liquid may be used. The ionic liquid preferably has a fluoroalkyl group-containing anion, more preferably an imide group-containing anion. Examples of such anion components that may be used include PF₆⁻, (CF₃SO₂)₂N⁻, (CF₃SO₂)₃C⁻, (C₂F₅SO₂)₂N⁻, (CF₃SO₂)(CF₃CO)N⁻, (FSO₂)₂N⁻, (C₃F₇SO₂)₂N⁻, (C₄F₉SO₂)₂N⁻, (C₂F₅)₃PF₃⁻, etc. In particular, fluorine atom-containing anion components are preferably used because they can form low-melting-point ionic liquids (ionic compounds).

Examples of the non-water-soluble (hydrophobic) ionic liquid to be used may be appropriately selected from combinations of any of the above cation components and any of the above anion components. Such examples include 1-butyl-3-methylpyridinium bis(trifluoromethanesulfonyl)imide, 1-butyl-3-methylpyridinium bis(pentafluoroethanesulfonyl)imide, 1,1-dimethylpyrrolidinium bis(trifluoromethanesulfonyl)imide, 1-methyl-1-ethylpyrrolidinium bis(trifluoromethanesulfonyl)imide, 1-methyl-1-propylpyrrolidinium bis(trifluoromethanesulfonyl)imide, 1-methyl-1-butylpyrrolidinium bis(trifluoromethanesulfonyl)imide, 1-methyl-1-pentylpyrrolidinium bis(trifluoromethanesulfonyl)imide, 1-methyl-1-hexylpyrrolidinium bis(trifluoromethanesulfonyl)imide, 1-methyl-1-heptylpyrrolidinium bis(trifluoromethanesulfonyl)imide, 1-ethyl-1-propylpyrrolidinium bis(trifluoromethanesulfonyl)imide, 1-ethyl-1-butylpyrrolidinium bis(trifluoromethanesulfonyl)imide, 1-ethyl-1-pentylpyrrolidinium bis(trifluoromethanesulfonyl)imide, 1-ethyl-1-hexylpyrrolidinium bis(trifluoromethanesulfonyl)imide, 1-ethyl-1-heptylpyrrolidinium bis(trifluoromethanesulfonyl)imide, 1,1-dipropylpyrrolidinium bis(trifluoromethanesulfonyl)imide, 1-propyl-1-butylpyrrolidinium bis(trifluoromethanesulfonyl)imide, 1,1-dibutylpyrrolidinium bis(trifluoromethanesulfonyl)imide, 1-propylpiperidinium bis(trifluoromethanesulfonyl)imide, 1-pentylpiperidinium bis(trifluoromethanesulfonyl)imide, 1,1-dimethylpiperidinium bis(trifluoromethanesulfonyl)imide, 1-methyl-1-ethylpiperidinium bis(trifluoromethanesulfonyl)imide, 1-methyl-1-propylpiperidinium bis(trifluoromethanesulfonyl)imide, 1-methyl-1-butylpiperidinium bis(trifluoromethanesulfonyl)imide, 1-methyl-1-pentylpiperidinium bis(trifluoromethanesulfonyl)imide, 1-methyl-1-hexylpiperidinium bis(trifluoromethanesulfonyl)imide, 1-methyl-1-heptylpiperidinium bis(trifluoromethanesulfonyl)imide, 1-ethyl-1-propylpiperidinium bis(trifluoromethanesulfonyl)imide, 1-ethyl-1-butylpiperidinium bis(trifluoromethanesulfonyl)imide, 1-ethyl-1-pentylpiperidinium bis(trifluoromethanesulfonyl)imide, 1-ethyl-1-hexylpiperidinium bis(trifluoromethanesulfonyl)imide, 1-ethyl-1-heptylpiperidinium bis(trifluoromethanesulfonyl)imide, 1,1-dipropylpiperidinium bis(trifluoromethanesulfonyl)imide, 1-propyl-1-butylpiperidinium bis(trifluoromethanesulfonyl)imide, 1,1-dibutylpiperidinium bis(trifluoromethanesulfonyl)imide, 1,1-dimethylpyrrolidinium bis(pentafluoroethanesulfonyl)imide, 1-methyl-1-ethylpyrrolidinium bis(pentafluoroethanesulfonyl)imide, 1-methyl-1-propylpyrrolidinium bis(pentafluoroethanesulfonyl)imide, 1-methyl-1-butylpyrrolidinium bis(pentafluoroethanesulfonyl)imide, 1-methyl-1-pentylpyrrolidinium bis(pentafluoroethanesulfonyl)imide, 1-methyl-1-hexylpyrrolidinium bis(pentafluoroethanesulfonyl)imide, 1-methyl-1-heptylpyrrolidinium bis(pentafluoroethanesulfonyl)imide, 1-ethyl-1-propylpyrrolidinium bis(pentafluoroethanesulfonyl)imide, 1-ethyl-1-butylpyrrolidinium bis(pentafluoroethanesulfonyl)imide, 1-ethyl-1-pentylpyrrolidinium bis(pentafluoroethanesulfonyl)imide, 1-ethyl-1-hexylpyrrolidinium bis(pentafluoroethanesulfonyl)imide, 1-ethyl-1-heptylpyrrolidinium bis(pentafluoroethanesulfonyl)imide, 1,1-dipropylpyrrolidinium bis(pentafluoroethanesulfonyl)imide, 1-propyl-1-butylpyrrolidinium bis(pentafluoroethanesulfonyl)imide, 1,1-dibutylpyrrolidinium bis(pentafluoroethanesulfonyl)imide, 1-propylpiperidinium bis(pentafluoroethanesulfonyl)imide, 1-pentylpiperidinium bis(pentafluoroethanesulfonyl)imide, 1,1-dimethylpiperidinium bis(pentafluoroethanesulfonyl)imide, 1-methyl-1-ethylpiperidinium bis(pentafluoroethanesulfonyl)imide, 1-methyl-1-propylpiperidinium bis(pentafluoroethanesulfonyl)imide, 1-methyl-1-butylpiperidinium bis(pentafluoroethanesulfonyl)imide, 1-methyl-1-pentylpiperidinium bis(pentafluoroethanesulfonyl)imide, 1-methyl-1-hexylpiperidinium bis(pentafluoroethanesulfonyl)imide, 1-methyl-1-heptylpiperidinium bis(pentafluoroethanesulfonyl)imide, 1-ethyl-1-propylpiperidinium bis(pentafluoroethanesulfonyl)imide, 1-ethyl-1-butylpiperidinium bis(pentafluoroethanesulfonyl)imide, 1-ethyl-1-pentylpiperidinium bis(pentafluoroethanesulfonyl)imide, 1-ethyl-1-hexylpiperidinium bis(pentafluoroethanesulfonyl)imide, 1-ethyl-1-heptylpiperidinium bis(pentafluoroethanesulfonyl)imide, 1,1-dipropylpiperidinium bis(pentafluoroethanesulfonyl)imide, 1-propyl-1-butylpiperidinium bis(pentafluoroethanesulfonyl)imide, 1,1-dibutylpiperidinium bis(pentafluoroethanesulfonyl)imide, 1-ethyl-3-methylimidazolium bis(trifluoromethanesulfonyl)imide, 1-ethyl-3-methylimidazolium bis(pentafluoroethanesulfonyl)imide, 1-ethyl-3-methylimidazolium tris(trifluoromethanesulfonyl)methide, 1-ethyl-3-methylimidazolium bis(trifluoromethanesulfonyl)imide, 1-butyl-3-methylimidazolium bis(trifluoromethanesulfonyl)imide, 1,2-dimethyl-3-propylimidazolium bis(trifluoromethanesulfonyl)imide, 1-ethyl-2,3,5-trimethylpyrazolium bis(trifluoromethanesulfonyl)imide, 1-propyl-2,3,5-trimethylpyrazolium bis(trifluoromethanesulfonyl)imide, 1-butyl-2,3,5-trimethylpyrazolium bis(trifluoromethanesulfonyl)imide, 1-ethyl-2,3,5-trimethylpyrazolium bis(pentafluoroethanesulfonyl)imide, 1-propyl-2,3,5-trimethylpyrazolium bis(pentafluoroethanesulfonyl)imide, 1-butyl-2,3,5-trimethylpyrazolium bis(pentafluoroethanesulfonyl)imide, 1-ethyl-2,3,5-trimethylpyrazolium bis(trifluoromethanesulfonyl)trifluoroacetamide, 1-propyl-2,3,5-trimethylpyrazolium bis(trifluoromethanesulfonyl)trifluoroacetamide, 1-butyl-2,3,5-trimethylpyrazolium bis(trifluoromethanesulfonyl)trifluoroacetamide, 1-ethyl-2,3,5-trimethylpyrazolinium bis(trifluoromethanesulfonyl)imide, 1-propyl-2,3,5-trimethylpyrazolinium bis(trifluoromethanesulfonyl)imide, 1-butyl-2,3,5-trimethylpyrazolinium bis(trifluoromethanesulfonyl)imide, 1-ethyl-2,3,5-trimethylpyrazolinium bis(pentafluoroethanesulfonyl)imide, 1-propyl-2,3,5-trimethylpyrazolinium bis(pentafluoroethanesulfonyl)imide, 1-butyl-2,3,5-trimethylpyrazolinium bis(pentafluoroethanesulfonyl)imide, 1-ethyl-2,3,5-trimethylpyrazolinium bis(trifluoromethanesulfonyl)trifluoroacetamide, 1-propyl-2,3,5-trimethylpyrazolinium bis(trifluoromethanesulfonyl)trifluoroacetamide, 1-butyl-2,3,5-trimethylpyrazolinium bis(trifluoromethanesulfonyl)trifluoroacetamide, tetrapentylammonium bis(trifluoromethanesulfonyl)imide, tetrahexylammonium bis(trifluoromethanesulfonyl)imide, tetraheptylammonium bis(trifluoromethanesulfonyl)imide, diallyldimethylammonium bis(trifluoromethanesulfonyl)imide, diallyldimethylammonium bis(pentafluoroethanesulfonyl)imide, N,N-diethyl-N-methyl-N-(2-methoxyethyl)ammonium bis(trifluoromethanesulfonyl)imide, N,N-diethyl-N-methyl-N-(2-methoxyethyl)ammonium bis(pentafluoroethanesulfonyl)imide, glycidyltrimethylammonium bis(trifluoromethanesulfonyl)imide, glycidyltrimethylammonium bis(pentafluoroethanesulfonyl)imide, tetraoctylphosphonium bis(trifluoromethanesulfonyl)imide, N,N-dimethyl-N-ethyl-N-propylammonium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexylammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylammonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylammonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N,N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethylheptylammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide, N,N-diethyl-N-methyl-N-heptylammonium bis(trifluoromethanesulfonyl)imide, N,N-diethyl-N-propyl-N-pentylammonium bis(trifluoromethanesulfonyl)imide, triethylpropylammonium bis(trifluoromethanesulfonyl)imide, triethylpentylammonium bis(trifluoromethanesulfonyl)imide, triethylheptylammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctylmethylammonium bis(trifluoromethanesulfonyl)imide, N-methyl-N-ethyl-N-propyl-N-pentylammonium bis(trifluoromethanesulfonyl)imide, 1-butylpyridinium (trifluoromethanesulfonyl)trifluoroacetamide, 1-butyl-3-methylpyridinium (trifluoromethanesulfonyl)trifluoroacetamide, 1-ethyl-3-methylimidazolium (trifluoromethanesulfonyl)trifluoroacetamide, 1-methyl-1-propylpyrrolidinium bis(fluorosulfonyl)imide, 1-methyl-1-propylpyrrolidiniumbis(fluorosulfonyl)imide, and 1-methyl-1-propylpiperidinium bis(fluorosulfonyl)imide. These are structurally characterized by having bis(trifluoromethanesulfonyl)imide, bis(pentafluoroethanesulfonyl)imide, bis(fluorosulfonyl)imide, tris(trifluoromethanesulfonyl)methide, (trifluoromethanesulfonyl)trifluoroacetamide, or bis(fluorosulfonyl)imide as an anion component.

Examples of commercially available products of the non-water-soluble (hydrophobic) ionic liquid include CIL-312 (N-butyl-3-methylpyridinium bis(trifluoromethylsulfonyl)imide) manufactured by Japan Carlit Co., Ltd. and Elexcel IL-110 (1-ethyl-3-methylimidazolium bis(fluorosulfonyl)imide), Elexcel IL-120 (1-methyl-1-propylpyrrolidinium bis(fluorosulfonyl)imide), Elexcel IL-130 (1-methyl-1-propylpiperidinium bis(fluorosulfonyl)imide), Elexcel IL-210 (1-ethyl-3-methylimidazolium bis(trifluoromethylsulfonyl)imide, Elexcel IL-220 (1-methyl-1-propylpyrrolidinium bis(trifluoromethylsulfonyl)imide), and Elexcel IL-230 (1-methyl-1-propylpiperidinium bis(trifluoromethylsulfonyl)imide) manufactured by Dai-ichi Kogyo Seiyaku Co., Ltd., etc.

The content of the non-water-soluble (hydrophobic) ionic liquid used in the present invention varies with the compatibility between the polymer and the ionic liquid to be used and is not uniquely specified. Based on 100 parts by weight (solid basis) of the base polymer (acrylic emulsion polymer), the non-water-soluble (hydrophobic) ionic liquid is preferably added in an amount of 10 parts by weight or less, more preferably 0.01 to 8 parts by weight, even more preferably 0.05 to 7 parts by weight, further more preferably 0.1 to 6 parts by weight, still more preferably 0.3 to 4.9 parts by weight, most preferably 0.5 to 3 parts by weight. If the content is less than 0.01 parts by weight, sufficient antistatic properties may fail to be obtained, and if the content is more than 10 parts by weight, staining on adherends may tend to increase.

### [Water-Soluble (Hydrophilic) Ionic Liquid]

As used herein, the term “water-soluble (hydrophilic) ionic liquid” refers to a molten salt (ionic compound) that is in a liquid state at 25° C. As a non-limiting example, a water-soluble (hydrophilic) ionic liquid composed of an anion component and any of organic cation components of formula (A) to (E) below is preferably used. The water-soluble (hydrophilic) ionic liquid is also simply referred to as the ionic liquid. Whether or not the ionic liquid is water-soluble can be evaluated as follows. The ionic liquid is added at a concentration of 10% by weight to water (25° C.), and they are mixed under the conditions of a rotational speed of 300 rpm and 10 minutes using a stirrer. Subsequently, after the mixture is allowed to stand for 30 minutes, whether separation or cloudiness occurs is visually checked. When neither separation nor cloudiness is observed, the ionic liquid is determined to be water-soluble (hydrophilic).

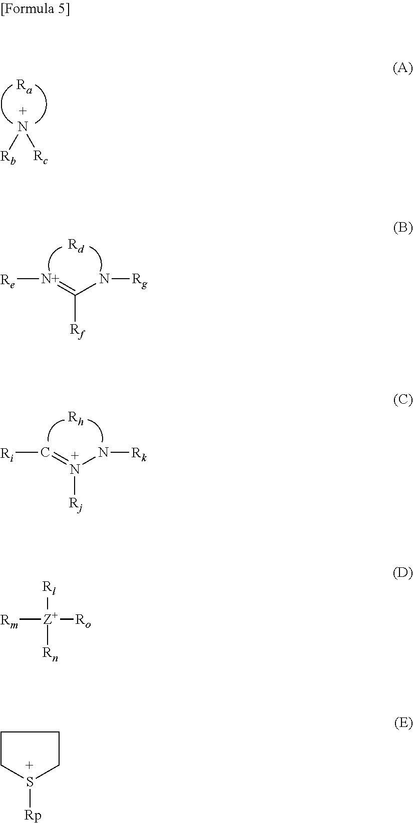

In formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent.

In formula (B), R_{d} represents a hydrocarbon group of 2 to 20 carbon atoms, part of the hydrocarbon group may be a heteroatom-substituted functional group, Rₑ, R_{f}, and R_{g} are the same or different and each represent hydrogen or a hydrocarbon group of 1 to 16 carbon atoms, and part of the hydrocarbon group may be a heteroatom-substituted functional group.

In formula (C), Rₕ represents a hydrocarbon group of 2 to 20 carbon atoms, part of the hydrocarbon group may be a heteroatom-substituted functional group, Rᵢ, Rⱼ, and Rₕ are the same or different and each represent hydrogen or a hydrocarbon group of 1 to 16 carbon atoms, and part of the hydrocarbon group may be a heteroatom-substituted functional group.

In formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent.

In formula (E), Rₚ represents a hydrocarbon group of 1 to 18 carbon atoms, and part of the hydrocarbon group may be a heteroatom-substituted functional group.

Examples of the cation of formula (A) include a pyridinium cation, a piperidinium cation, a pyrrolidinium cation, a pyrroline skeleton-containing cation, a pyrrole skeleton-containing cation, and a morpholinium cation.

Specific examples include a 1-ethylpyridinium cation, a 1-butylpyridinium cation, a 1-hexylpyridinium cation, a 1-butyl-3-methylpyridinium cation, a 1-butyl-4-methylpyridinium cation, a 1-hexyl-3-methylpyridinium cation, a 1-butyl-3,4-dimethylpyridinium cation, a 1,1-dimethylpyrrolidinium cation, a 1-ethyl-1-methylpyrrolidinium cation, a 1-methyl-1-propylpyrrolidinium cation, a 1-methyl-1-butylpyrrolidinium cation, a 1-methyl-1-pentylpyrrolidinium cation, a 1-methyl-1-hexylpyrrolidinium cation, a 1-methyl-1-heptylpyrrolidinium cation, a 1-ethyl-1-propylpyrrolidinium cation, a 1-ethyl-1-butylpyrrolidinium cation, a 1-ethyl-1-pentylpyrrolidinium cation, a 1-ethyl-1-hexylpyrrolidinium cation, a 1-ethyl-1-heptylpyrrolidinium cation, a 1,1-dipropylpyrrolidinium cation, a 1-propyl-1-butylpyrrolidinium cation, a 1,1-dibutylpyrrolidinium cation, a 1-propylpiperidinium cation, a 1-pentylpiperidinium cation, a 1,1-dimethylpiperidinium cation, a 1-methyl-1-ethylpiperidinium cation, a 1-methyl-1-propylpiperidinium cation, a 1-methyl-1-butylpiperidinium cation, a 1-methyl-1-pentylpiperidinium cation, a 1-methyl-1-hexylpiperidinium cation, a 1-methyl-1-heptylpiperidinium cation, a 1-ethyl-1-propylpiperidinium cation, a 1-ethyl-1-butylpiperidinium cation, a 1-ethyl-1-pentylpiperidinium cation, a 1-ethyl-1-hexylpiperidinium cation, a 1-ethyl-1-heptylpiperidinium cation, a 1,1-dipropylpiperidinium cation, a 1-propyl-1-butylpiperidinium cation, a 1,1-dibutylpiperidinium cation, a 2-methyl-1-pyrroline cation, a 1-ethyl-2-phenylindole cation, a 1,2-dimethylindole cation, a 1-ethylcarbazole cation, and an N-ethyl-N-methylmorpholinium cation.

Examples of the cation of formula (B) include an imidazolium cation, a tetrahydropyrimidinium cation, and a dihydropyrimidinium cation.

Specific examples include a 1,3-dimethylimidazolium cation, a 1,3-diethylimidazolium cation, a 1-ethyl-3-methylimidazolium cation, a 1-butyl-3-methylimidazolium cation, a 1-hexyl-3-methylimidazolium cation, a 1-ocytl-3-methylimidazolium cation, a 1-decyl-3-methylimidazolium cation, a 1-dodecyl-3-methylimidazolium cation, a 1-tetradecyl-3-methylimidazolium cation, a 1,2-dimethyl-3-propylimidazolium cation, a 1-ethyl-2,3-dimethylimidazolium cation, a 1-butyl-2,3-dimethylimidazolium cation, a 1-hexyl-2,3-dimethylimidazolium cation, a 1,3-dimethyl-1,4,5,6-tetrahydropyrimidinium cation, a 1,2,3-trimethyl-1,4,5,6-tetrahydropyrimidinium cation, a 1,2,3,4-tetramethyl-1,4,5,6-tetrahydropyrimidinium cation, a 1,2,3,5-tetramethyl-1,4,5,6-tetrahydropyrimidinium cation, a 1,3-dimethyl-1,4-dihydropyrimidinium cation, a 1,3-dimethyl-1,6-dihydropyrimidinium cation, a 1,2,3-trimethyl-1,4-dihydropyrimidinium cation, a 1,2,3-trimethyl-1,6-dihydropyrimidinium cation, a 1,2,3,4-tetramethyl-1,4-dihydropyrimidinium cation, and a 1,2,3,4-tetramethyl-1,6-dihydropyrimidinium cation.

Examples of the cation of formula (C) include a pyrazolium cation and a pyrazolinium cation.

Specific examples include a 1-methylpyrazolium cation, a 3-methylpyrazolium cation, a 1-ethyl-2-methylpyrazolinium cation, a 1-ethyl-2,3,5-trimethylpyrazolium cation, a 1-propyl-2,3,5-trimethylpyrazolium cation, a 1-butyl-2,3,5-trimethylpyrazolium cation, a 1-ethyl-2,3,5-trimethylpyrazolinium cation, a 1-propyl-2,3,5-trimethylpyrazolinium cation, and a 1-butyl-2,3,5-trimethylpyrazolinium cation.

Examples of the cation of formula (D) include a tetraalkylammonium cation, a trialkylsulfonium cation, a tetraalkylphosphonium cation, and derivatives thereof in which part of the alkyl group is replaced by an alkenyl group, an alkoxyl group, a hydroxyl group, a cyano group, or an epoxy group.

Specific examples include a tetramethylammonium cation, a tetraethylammonium cation, a tetrabutylammonium cation, a tetrapentylammonium cation, a tetrahexylammonium cation, a tetraheptylammonium cation, a triethylmethylammonium cation, a tributylethylammonium cation, an N,N-diethyl-N-methyl-N-(2-methoxyethyl)ammonium cation, a glycidyltrimethylammonium cation, a trimethylsulfonium cation, a triethylsulfonium cation, a tributylsulfonium cation, a trihexylsulfonium cation, a diethylmethylsulfonium cation, a dibutylethylsulfonium cation, a tetramethylphosphonium cation, a tetraethylphosphonium cation, a tetrabutylphosphonium cation, a tetrahexylphosphonium cation, a tetraoctylphosphonium cation, a triethylmethylphosphonium cation, a tributylethylphosphonium cation, and a diallyldimethylammonium cation. In particular, preferably used are unsymmetrical tetraalkylammonium cations such as a triethylmethylammonium cation, a tributylethylammonium cation, a diethylmethylsulfonium cation, a dibutylethylsulfonium cation, a triethylmethylsulfonium cation, a tributylethylphosphonium cation, and a trimethyldecylphosphonium cation, a trialkylsulfonium cation, a tetraalkylphosphonium cation, an N,N-diethyl-N-methyl-N-(2-methoxyethyl)ammonium cation, a glycidyltrimethylammonium cation, a diallyldimethylammonium cation, an N,N-dimethyl-N-ethyl-N-propylammonium cation, an N,N-dimethyl-N-ethyl-N-butylammonium cation, an N,N-dimethyl-N-ethyl-N-pentylammonium cation, an N,N-dimethyl-N-ethyl-N-hexylammonium cation, an N,N-dimethyl-N-ethyl-N-heptylammonium cation, an N,N-dimethyl-N-ethyl-N-nonylammonium cation, an N,N-dimethyl-N,N-dipropylammonium cation, an N,N-diethyl-N-propyl-N-butylammonium cation, an N,N-dimethyl-N-propyl-N-pentylammonium cation, an N,N-dimethyl-N-propyl-N-hexylammonium cation, an N,N-dimethyl-N-propyl-N-heptylammonium cation, an N,N-dimethyl-N-butyl-N-hexylammonium cation, an N,N-diethyl-N-butyl-N-heptylammonium cation, an N,N-dimethyl-N-pentyl-N-hexylammonium cation, an N,N-dimethyl-N,N-dihexylammonium cation, a trimethylheptylammonium cation, an N,N-diethyl-N-methyl-N-propylammonium cation, an N,N-diethyl-N-methyl-N-pentylammonium cation, an N,N-diethyl-N-methyl-N-heptylammonium cation, an N,N-diethyl-N-propyl-N-pentylammonium cation, a triethylpropylammonium cation, a triethylpentylammonium cation, a triethylheptylammonium cation, an N,N-dipropyl-N-methyl-N-ethylammonium cation, an N,N-dipropyl-N-methyl-N-pentylammonium cation, an N,N-dipropyl-N-butyl-N-hexylammonium cation, an N,N-dipropyl-N,N-dihexylammonium cation, an N,N-dibutyl-N-methyl-N-pentylammonium cation, an N,N-dibutyl-N-methyl-N-hexylammonium cation, a trioctylmethylammonium cation, and an N-methyl-N-ethyl-N-propyl-N-pentylammonium cation.

For example, the cation of formula (E) may be a sulfonium cation or the like. Examples of Rₚ in formula (E) include a methyl group, an ethyl group, a propyl group, a butyl group, a hexyl group, an octyl group, a nonyl group, a decyl group, a dodecyl group, a tridecyl group, a tetradecyl group, and an octadecyl group.

In the water-dispersible acrylic pressure-sensitive adhesive composition of the present invention, the cation of the ionic liquid is preferably of at least one selected from the group consisting of an imidazolium-containing salt type, a pyridinium-containing salt type, a morpholinium-containing salt type, a pyrrolidinium-containing salt type, a piperidinium-containing salt type, an ammonium-containing salt type, a phosphonium-containing salt type, and a sulfonium-containing salt type. Herein, these ionic liquids contain one of the cations of formulae (A), (B), and (D).

In the water-dispersible acrylic pressure-sensitive adhesive composition of the present invention, the ionic liquid preferably contains at least one cation selected from the group consisting of cations represented by formulae (a) to (d) below. Herein, these cations are included in those of formulae (A) and (B).

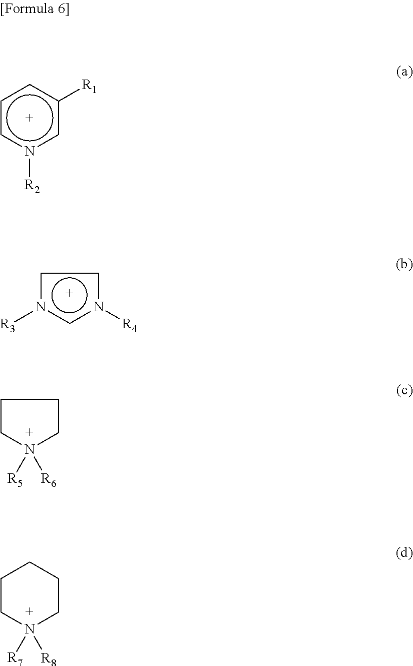

In formula (a), R₁ represents hydrogen or a hydrocarbon group of 1 to 3 carbon atoms, preferably hydrogen or a hydrocarbon group of one carbon atom, and R₂ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (b), R₃ represents hydrogen or a hydrocarbon group of 1 to 3 carbon atoms, preferably hydrogen or a hydrocarbon group of one carbon atom, and R₄ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (c), R₅ represents hydrogen or a hydrocarbon group of 1 to 3 carbon atoms, preferably hydrogen or a hydrocarbon group of one carbon atom, and R₆ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (d), R₇ represents hydrogen or a hydrocarbon group of 1 to 3 carbon atoms, preferably hydrogen or a hydrocarbon group of one carbon atom, and R₈ represents hydrogen or a hydrocarbon group of 1 to 7 carbon atoms, preferably a hydrocarbon group of 1 to 6 carbon atoms, more preferably a hydrocarbon group of 1 to 4 carbon atoms.

On the other hand, any anion component capable of forming the water-soluble (hydrophilic) ionic liquid may be used, examples of which include Cl⁻, Br⁻, I⁻, BF₄⁻, PF₆⁻, ClO₄⁻, NO₃⁻, CH₃COO⁻, CF₃COO⁻, CH₃SO₃⁻, CF₃SO₃⁻, (CN)₂N⁻, C₄F₉SO₃⁻, C₃F₂COO⁻, C₂F₅SO₃⁻, C₃F₂SO₃⁻, C₄F₉SO₃⁻, (CH₃O)₂PO₂⁻, (C₂H₅O)₂PO₂⁻, CH₃OSO₃⁻, C₄H₉OSO₃⁻, C₂H₅OSO₃⁻, n-C₆H₁₃OSO₃⁻, n-C₈H₁₇OSO₃⁻, CH₃ (OC₂H₄)₂OSO₃⁻, SCN⁻, HSO₄⁻, and CH₃C₆H₄SO₃⁻. In particular, fluorine atom-containing anion components are preferably used because they can form low-melting-point ionic compounds.

The content of the water-soluble (hydrophilic) ionic liquid varies with the compatibility between the polymer and the ionic liquid to be used and is not uniquely specified. Based on 100 parts by weight (solid basis) of the base polymer (acrylic emulsion polymer), the content of the water-soluble (hydrophilic) ionic liquid is preferably 10 parts by weight or less, more preferably 4 parts by weight or less, even more preferably from 0.001 to 3 parts by weight, further more preferably from 0.01 to 2 parts by weight, most preferably from 0.1 to 1 part by weight. If the content is more than 10 parts by weight, staining on an adherend may tend to increase, or appearance characteristics may tend to degrade. When the water-soluble (hydrophilic) ionic liquid is used in combination with the polyether antifoamer, the water-soluble (hydrophilic) ionic liquid and the polyether antifoamer can interact with each other to increase the interfacial adsorption amount, so that antistatic properties and other properties can be obtained even when the content of the water-soluble (hydrophilic) ionic liquid is low, which is advantageous.

The ionic liquid (non-water-soluble ionic liquid and a water-soluble ionic liquid) described above may be a commercially available product or may be synthesized as described below. The ionic liquid may be synthesized by any method capable of producing the desired ionic liquid. In general, the ionic liquid is synthesized using methods described in the document titled “Ionic Liquids—the Front Line of Development and the Future-” published by CMC Publishing Co., Ltd., such as halide method, hydroxide method, acid ester method, complex-forming method, and neutralization method.

Hereinafter, how to synthesize nitrogen-containing onium salts by halide method, hydroxide method, acid ester method, complex-forming method, and neutralization method will be shown as an example. It will be understood that other ionic liquids such as sulfur-containing onium salts and phosphorus-containing onium salts can also be obtained by the same techniques.

Halide method is performed using the reactions represented by formulae (1) to (3) below. First, a tertiary amine and an alkyl halide are allowed to react to form a halide (reaction formula (1), the halogen used is chlorine, bromine, or iodine).

The resulting halide is allowed to react with an acid (HA) having the anion structure (A⁻) of the desired ionic liquid or to react with a salt (MA, M is a cation capable of forming a salt with the desired anion, such as ammonium, lithium, sodium, or potassium), so that the desired ionic liquid (R₄NA) is obtained.

[Formula 7]

R₃N+RX→R₄NX (X: Cl, Br, I) (1)

R₄NX+HA→R₄NA+HX (2)

R₄NX+MA→R₄NA+MX (M: NH₄, Li, Na, K, Ag, or the like) (3)

Hydroxide method is performed using the reactions represented by formulae (4) to (8). First, a halide (R₄NX) is subjected to ion exchange membrane electrolysis (reaction formula (4)), OH-type ion exchange resin method (reaction formula (5)), or reaction with silver oxide (Ag₂O) (reaction formula (6)), so that a hydroxide (R₄NOH) is obtained (the halogen used is chlorine, bromine, or iodine).

The resulting hydroxide is subjected to the reactions of formulae (7) and (8) similarly to the halide method, so that the desired ionic liquid (R₄NA) is obtained.

[Formula 8]

R₄NX+H₂O→R₄NOH+½H₂+½X₂ (X: Cl, Br, I) (4)

R₄NX+P—OH→R₄NOH+P—X (P—OH: OH-type ion exchange resin) (5)

R₄NX+½Ag₂O+½H₂O→R₄NOH+AgX (6)

R₄NOH+HA→R₄NA+H₂O (7)

R₄NOH+MA→R₄NA+MOH (M: NH₄, Li, Na, K, Ag, or the like) (8)

Acid ester method is performed using the reactions represented by formulae (9) to (11) below. First, a tertiary amine (R₃N) is allowed to react with an acid ester to form an acid ester derivative (reaction formula (9), the acid ester used is an ester of an inorganic acid such as sulfuric acid, sulfurous acid, phosphoric acid, phosphorous acid, or carbonic acid or an ester of an organic acid such as methanesulfonic acid, methylphosphonic acid, or formic acid).

The resulting acid ester derivative is subjected to the reactions of formulae (10) and (11) similarly to the halide method, so that the desired ionic liquid (R₄NA) is obtained. Alternatively, methyl trifluoromethanesulfonate, methyl trifluoroacetate, or the like may be used as the acid ester so that the ionic liquid can be directly obtained.

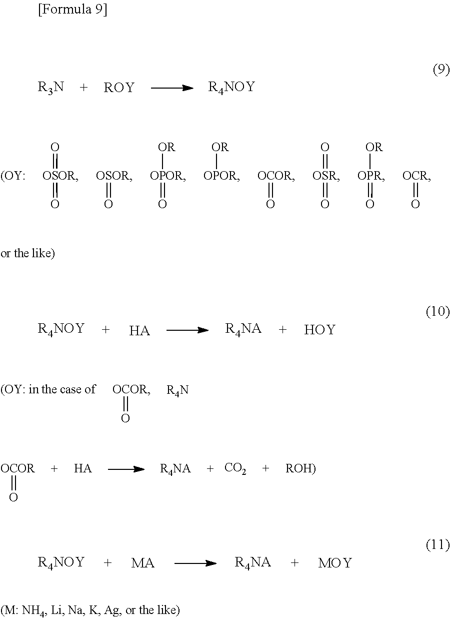

Complex-forming method is performed using the reactions represented by formulae (12) to (15). First, a quaternary ammonium halide (R₄NX), a quaternary ammonium hydroxide (R₄NOH), a quaternary ammonium carbonate (R₄NOCO₂CH₃), or the like is allowed to react with hydrogen fluoride (HF) or ammonium fluoride (NH₄F) to form a quaternary ammonium fluoride salt (reaction formulae (12) to (14)).

The resulting quaternary ammonium fluoride salt is subjected to a complex-forming reaction with a fluoride such as BF₃, AlF₃, PF₅, ASF₅, SbF₅, NbF₅, or TaF₅ so that an ionic liquid can be obtained (reaction formula (15)).

[Formula 10]

R₄NX+HF→R₄NF+HX (X: Cl, Br, I) (12)

R₄NY+HF→R₄NF+HY (Y: OH, OCO₂CH₃) (13)

R₄NY+NH₄F→R₄NF+NH₃+HY (Y: OH, OCO₂CH₃) (14)

R₄NF+MFₙ₋₁→R₄NMFₙ (MFₙ₋₁═BF₃, AlF₃, PF₅, ASF₅, SbF₅, NbF₅, TaF₅, or the like) (15)

Neutralization method is performed using the reaction represented by formula (16). A tertiary amine is allowed to react with HBF₄, HPF₆, or an organic acid such as CH₃COOH, CF₃COOH, CF₃SO₃H, (CF₃SO₂)₂NH, (CF₃SO₂)₃CH, or (C₂F₅SO₂)₂NH to form an ionic liquid.

[Formula 11]

R₃N+HZ→R₃HN⁺Z⁻ [HZ: HBF₄, HPF₆, CH₃COOH, CF₃COOH, CF₃SO₃H, An organic acid such as (CF₃SO₂)₂NH, (CF₃SO₂)₃CH, or (C₂F₅SO₂)₂NH] (16)

In formulae (1) to (16), R represents hydrogen or a hydrocarbon group of 1 to 20 carbon atoms, and part of the hydrocarbon group may be a heteroatom-substituted functional group.

### [Alkali Metal Salt]

In the present invention, the alkali metal salt is typically, but not limited to, a lithium salt, a sodium salt, or a potassium salt. Specific examples of the metal salt that are preferably used include metal salts composed of any of Li⁺, Na⁺, and K⁺ cations and any of Cl⁻, Br⁻, I⁻, BF₄⁻, PF₆⁻, SCN⁻, ClO₄⁻, CF₃SO₃⁻, (CF₃SO₂)₂N⁻, (C₂F₅SO₂)₂N⁻, (CF₃SO₂)₃C⁻, C₄F₉SO₃⁻, CH₃COO⁻, C₃F₇COO⁻, (CF₃SO₂) (CF₃CO)N⁻, (FSO₂)₂N⁻, (C₄F₉SO₂)₂N⁻, (CH₃O)₂PO₂⁻, (C₂H₅O)₂PO₂⁻, (CN)₂N⁻, CH₃OSO₃⁻, C₂H₅OSO₃⁻, and n-C₈H₁₇OSO₃⁻ anions. In particular, a fluorine-containing anion is preferably used to form the salt. In a preferred mode, a lithium salt such as LiBr, LiI, LiBF₄, LiPF₆, LiSCN, LiClO₄, LiCF₃SO₃, Li(CF₃SO₂)₂N, Li(C₂F₅SO₂)₂N, or Li(CF₃SO₂)₃C is used. Among alkali metal salts, lithium salts are particularly highly dissociative. Using a lithium salt, therefore, a highly antistatic pressure-sensitive adhesive layer (pressure-sensitive adhesive sheet) can be obtained, which can be used as a surface protecting film for optical members and other products that need to be antistatic. Herein, these alkali metal salts may be used singly or in combination of two or more.

The content of the alkali metal salt used in the present invention is preferably 5 parts by weight or less, more preferably 3 parts by weight or less, even more preferably 2 parts by weight or less, most preferably from 0.1 to 1 part by weight, based on 100 parts by weight of the (meth)acryl-based polymer. If the content is more than 5 parts by weight, staining on the adherend (object to be protected) may tend to increase, which is not preferred.

### [Polyether Antifoamer]

The removable water-dispersible acrylic pressure-sensitive adhesive composition of the present invention contains, as an essential component, a polyether antifoamer having the specific structure shown below. Not only antifoaming and less-staining properties can be imparted by adding the polyether antifoamer, but also the antifoamer can function as a release aid. Therefore, for example, when the pressure-sensitive adhesive composition of the present invention is used to forma surface protecting film or the like, the pressure-sensitive adhesive can be peeled off with high removal stability even at low or high peeling rate after the use of the surface protecting film or the like, which is an advantageous effect of the composition of the present invention. The polyether antifoamer is a compound represented by formula (I) below.

HO—(PO)ₙ₁(EO)ₘ₁—H (I)

In formula (I), PO represents an oxypropylene group, and EO represents an oxyethylene group. In formula (I), m1 represents an integer of 0 to 40, n1 represents an integer of 1 or more, and m1 is preferably 1 to 40, more preferably 2 to 35, even more preferably 2 to 27, further more preferably 3 to 25. In formula (I), n1 is preferably 10 to 69, more preferably 10 to 65, even more preferably 12 to 55, further more preferably 15 to 40. When m1 and n1 each fall within the range, the composition can be less-staining on adherends, which is preferred. EO and PO are added in a random form or a block form. Herein, when m1 is 0, formula (I) is HO—(PO)ₙ₁—H which represents polypropylene glycol.

In formula (I), EO and PO are added (copolymerized) in a random form (to form a random copolymer) or in a block form (to form a block copolymer). When EO and PO are added in a block form, the respective blocks may be arranged, for example, in (EO block)-(PO block)-(EO block) structure, (PO block)-(EO block)-(PO block) structure, (EO block)-(PO block) structure, or (PO block)-(EO block) structure.

The polyether antifoamer is preferably the compound of formula (I) because it can provide a particularly good balance between antifoaming and less-staining properties. In a particularly preferred mode, EO and PO are added (copolymerized) in a block form (to form a block copolymer), and the respective blocks are arranged in (PO block)-(EO block)-(PO block) structure. In other words, the polyether antifoamer is preferably a triblock copolymer having PO blocks at both ends of an EO block.

The polyether antifoamer is preferably a compound represented by formula (II) below.

HO—(PO)ₐ-(EO)_{b}—(PO)_{c}—H (II)

In formula (II), PO represents an oxypropylene group, and EO represents an oxyethylene group. In formula (II), a and c are each preferably an integer of 1 or more, more preferably a and c are each 1 to 100, even more preferably 10 to 50, further more preferably 10 to 30. In formula (II), a and c may be the same or different. In formula (II), b is preferably an integer of 1 or more, more preferably 1 to 50, even more preferably 1 to 30. When a to c each fall within the range, the composition can be less-staining on adherends, which is preferred.

When the polyether antifoamer ((I) and (II)) is added to the removable water-dispersible acrylic pressure-sensitive adhesive composition, its antifoaming property can prevent foam-induced defects. In addition, the polyether antifoamer can bleed to the interface between the pressure-sensitive adhesive layer and the adherend to provide a release control function, which enables lightly removable design (when the polyether antifoamer is added in an increased amount, the resulting composition can be less-staining and lightly removable). Because of the ether group, although the detailed reason is not clear, the use of the polyether antifoamer makes it possible to obtain good compatibility and well-balanced interaction between the ionic compound (non-water-soluble (hydrophobic) ionic liquid or water-soluble ionic liquid) and the acrylic emulsion polymer and other materials. This is advantageous in that the resulting surface protecting film can be less-staining on an adherend and prevented from causing static build-up on a non-antistatic adherend (object to be protected) when peeled off from the adherend.

The polyether antifoamer of formula (II) has a block-type structure in which the polyoxyethylene block is located at the center of the molecule, and PO blocks (hydrophobic groups) are located at both ends of the molecule. This structure makes the molecule less likely to uniformly align at a gas-liquid interface and is effective in providing antifoaming properties. As compared with a PPG-PEG-PPG triblock copolymer, a PEG-PPG-PEG triblock copolymer having polyoxyethylene blocks at both ends of the molecule or a polyoxyethylene-polyoxypropylene diblock copolymer tends to uniformly align at a gas-liquid interface and thus can have a function to stabilize a foam.

Further, the polyether antifoamer ((I) and (II)) is highly hydrophobic and therefore is less likely to cause white staining on an adherend in a high-humidity environment and can improve the less-staining properties. In a high-humidity environment, a highly hydrophilic compound (especially, a water-soluble compound) can dissolve in water to become more likely to transfer to an adherend or can bleed to an adherend to swell and be whitened, and therefore can easily cause white staining.

Concerning the polyether antifoamer ((I) and (II)), the ratio of the total weight of PO to the total weight of the polyether antifoamer [{(the total weight of PO)/(the total weight of the polyether antifoamer)}×100] (in units of % by weight (%)) is preferably from 50 to 95% by weight, more preferably from 55 to 90% by weight, even more preferably from 60 to 85% by weight. If the ratio (PO content) is less than 50% by weight, the polyether antifoamer may have high hydrophilicity so that the antifoaming properties may fail to be obtained or staining may occur on an adherend. If the ratio is more than 95% by weight, the polyether antifoamer may have too high hydrophobicity, which may cause repellent. In view of less-staining properties, the PO content is preferably 95% by weight or less. The term “the total weight of the polyether antifoamer” refers to the total weight of all the polyether antifoamers in the pressure-sensitive adhesive composition of the invention, and the term “the total weight of PO” refers to the total weight of PO in all the polyether antifoamers in the pressure-sensitive adhesive composition of the invention. The ratio (% by weight) of the total weight of PO (oxypropylene group) in all the polyether antifoamers to the total weight of the polyether antifoamers in the water-dispersible pressure-sensitive adhesive composition of the invention is also referred to as the “PO content.” The PO content can be determined, for example, using NMR, chromatographic method (chromatography), matrix for matrix assisted laser desorption/ionization-time of flight mass spectrometry (MALDI-TOFMS), or time-of-flight secondary ion mass spectrometry (TOF-SIMS).

In the removable water-dispersible acrylic pressure-sensitive adhesive composition (pressure-sensitive adhesive composition) of the present invention, the polyether antifoamer preferably has a number average molecular weight (Mn) of 1,200 to 4,000, more preferably 1,250 to 3,500, even more preferably 1,330 to 3,000, further more preferably 1,500 to 3,000. If the number average molecular weight is less than 1,200, the polyether antifoamer may have too high compatibility with the system (the pressure-sensitive adhesive composition system), so that the antifoaming effect may fail to be obtained or staining may occur on an adherend. If the number average molecular weight (Mn) is more than 4,000, the antifoamer may be excessively non-compatible with the system, so that repellent may occur in the process of applying the pressure-sensitive adhesive composition to a substrate or other materials although the antifoaming properties will be high. Herein, the number average molecular weight (Mn) refers to the number average molecular weight of all the polyether antifoamers in the water-dispersible acrylic pressure-sensitive adhesive composition of the present invention. The number average molecular weight (Mn) refers to the value obtained by gel permeation chromatography (GPC) measurement. Specifically, the measurement method described below may be used.

The polyether antifoamer may be a commercially available product, examples of which include ADEKA PLURONIC 17R-4 (trade name) (2,500 in number average molecular weight), ADEKA PLURONIC 17R-2 (trade name) (2,000 in number average molecular weight), ADEKA PLURONIC 25R-1 (trade name) (2,800 in number average molecular weight), ADEKA PLURONIC 25R-2 (trade name) (3,000 in number average molecular weight), ADEKA PLURONIC L-62 (trade name) (2,200 in number average molecular weight), and ADEKA PLURONIC P-84 (trade name) (3,750 in number average molecular weight) manufactured by ADEKA CORPORATION. Examples of the commercially available product also include Plonon 101P, Plonon 183, Plonon 201, Plonon 202B, Plonon 352, Unilube 10MS-250 KB, and Unilube 20MT-2000B (trade names) manufactured by NOF CORPORATION; and ADEKA PLURONIC L-33, ADEKA PLURONIC L-42, ADEKA PLURONIC L-43, ADEKA PLURONIC L-61, ADEKA PLURONIC L-71, ADEKA PLURONIC L-72, ADEKA PLURONIC L-81, ADEKA PLURONIC L-92, ADEKA PLURONIC L-101, and ADEKA PLURONIC 17R-3 (trade names) manufactured by ADEKA CORPORATION. In particular, ADEKA PLURONIC 25R-1 and ADEKA PLURONIC 25R-2 are preferably used, which belong to those having a PO content of 50 to 90% by weight and a number average molecular weight of 1,200 to 4,000.

These polyether antifoamers may be used singly or in combination of two or more.

In the process of preparing the pressure-sensitive adhesive composition of the present invention, the polyether antifoamer is preferably added by itself with no solvent. For purposes such as improvement of the workability of mixing, however, a dispersion or solution of the polyether antifoamer in any of various solvents may also be used. Examples of the solvent include 2-ethylhexanol, butyl cellosolve, dipropylene glycol, ethylene glycol, propylene glycol, n-propyl alcohol, and isopropanol. Among these solvents, ethylene glycol is preferably used in view of dispersibility in the emulsion system.

Based on 100 parts by weight of the acrylic emulsion polymer, the added amount of the polyether antifoamer (the content of the antifoamer in the pressure-sensitive adhesive composition) is preferably 10 parts by weight or less, more preferably 6 parts by weight or less, even more preferably from 0.01 to 5 parts by weight, further more preferably from 0.01 to 2 parts by weight, still more preferably from 0.05 to 3 parts by weight, yet more preferably from 0.1 to 2 parts by weight, most preferably from 0.1 to 1 part by weight. If the content is less than 0.01 parts by weight, antifoaming properties may fail to be provided, and if the content is more than 10 parts by weight, staining may easily occur on adherends in some cases.

The water-dispersible acrylic pressure-sensitive adhesive composition of the present invention may also contain a polyoxyalkylene compound other than the polyether antifoamer (such a compound is also referred to as “any other polyoxyalkylene compound”) for the purpose of further improving the antifoaming effect. Examples of any other polyoxyalkylene compound include products of reaction of an alkylene oxide of 2 or 4 carbon atoms with a monoalcohol of 4 to 18 carbon atoms (such as butyl alcohol, isoamyl alcohol, n-amyl alcohol, hexyl alcohol, heptyl alcohol, octyl alcohol, capryl alcohol, nonyl alcohol, decyl alcohol, undecyl alcohol, lauryl alcohol, tridecyl alcohol, myristyl alcohol, pentadecyl alcohol, cetyl alcohol, heptadecyl alcohol, or stearyl alcohol), a monocarboxylic acid of 4 to 18 carbon atoms (such as butyric acid, valeric acid, capric acid, enanthic acid, caprylic acid, pelargonic acid, undecylic acid, lauric acid, tridecylic acid, myristic acid, pentadecylic acid, palmitic acid, heptadecylic acid, or stearic acid), or a monoamine of 4 to 18 carbon atoms (such as butylamine, octylamine, laurylamine, or stearylamine); and products of reaction of an alkylene oxide of 2 or 4 carbon atoms with a polyol of 3 to 60 carbon atoms (such as glycerin, trimethylolpropane, trimethylolbutane, pentaerythritol, a formalin condensate of phenol or alkyl phenol (such as octyl phenol, nonyl phenyl, or butyl phenol), a sugar (such as glycoside, sucrose, isosaccharose, trehalose, isotrehalose, gentianose, melezitose, planteose, or raffinose).

The content of any other polyoxyalkylene compound is preferably 120 parts by weight or less, more preferably from 1 to 115 parts by weight, even more preferably from 3 to 110 parts by weight, most preferably from 5 to 100 parts by weight, based on 100 parts by weight of the polyether antifoamer.

### [Removable Water-Dispersible Acrylic Pressure-Sensitive Adhesive Composition]

As described above, the removable water-dispersible acrylic pressure-sensitive adhesive composition (pressure-sensitive adhesive composition) of the present invention contains, as essential components, the acrylic emulsion polymer, the ionic compound, and the polyether antifoamer having the specified structure. If necessary, the composition may contain any of various other additives.

In a preferred mode, the pressure-sensitive adhesive composition of the present invention is substantially free of what are called nonreactive (non-polymerizable) components (except for water and other components that are evaporated by drying and do not remain in the pressure-sensitive adhesive layer after drying) other than reactive (polymerizable) components capable of being incorporated into the polymer as a component of the pressure-sensitive adhesive layer by reacting (being polymerized) with the raw material monomers or other components of the acrylic emulsion polymer. If nonreactive components remain in the pressure-sensitive adhesive layer, the components may transfer to an adherend to cause white staining in some cases. Herein, the term “substantially free of” means that the components are not intensionally added and may be contained as inevitable contaminants. Specifically, the content of such nonreactive components (nonvolatile components) in the pressure-sensitive adhesive composition is preferably less than 1% by weight, more preferably less than 0.1% by weight, even more preferably less than 0.005% by weight.

Examples of such nonreactive components include components capable of bleeding to the surface of the pressure-sensitive adhesive layer and imparting peelability, such as phosphate ester compounds disclosed in JP-A-2006-45412. Examples also include nonreactive emulsifiers such as sodium lauryl sulfate and ammonium lauryl sulfate.

The pressure-sensitive adhesive composition of the invention may contain various additives other than the above as long as the less-staining properties are not affected. Examples of such additives include pigments, fillers, leveling agents, dispersing agents, plasticizers, stabilizers, antioxidants, ultraviolet absorbers, ultraviolet stabilizers, antifoamer, age resisters, and preservatives.

The pressure-sensitive adhesive composition of the present invention can be prepared by mixing the acrylic emulsion polymer, the ionic compound, and the polyether antifoamer having the specified structure. If necessary, any of various other additives may also be mixed. The mixing method may be a known conventional mixing method for forming an emulsion. As a non-limiting example, stirring using a stirrer is preferred. As a non-limiting example of stirring conditions, the stirring temperature is preferably from 10 to 50° C., more preferably from 20 to 35° C. The stirring time is preferably from 5 to 30 minutes, more preferably from 10 to 20 minutes. The stirring rotation number is preferably from 10 to 3,000 rpm, more preferably from 30 to 1,000 rpm.

### [Pressure-Sensitive Adhesive Layer and Pressure-Sensitive Adhesive Sheet]

The pressure-sensitive adhesive layer (pressure-sensitive adhesive sheet) of the present invention is made from the removable water-dispersible acrylic pressure-sensitive adhesive composition. The pressure-sensitive adhesive layer can be formed using any known conventional pressure-sensitive adhesive layer-forming method. The pressure-sensitive adhesive layer can be formed by a process including applying the pressure-sensitive adhesive composition onto a substrate or a release film (release liner) and then drying the composition. The pressure-sensitive adhesive layer formed on the release (separator) film is bonded to a substrate so that it can be transferred onto the substrate.

In the process of forming the pressure-sensitive adhesive layer (pressure-sensitive adhesive sheet), the drying temperature is generally from about 80 to about 170° C., preferably from 80 to 160° C., and the drying time is generally from about 0.5 to about 30 minutes, preferably from 1 to 10 minutes. Subsequently, curing (aging) should be further performed at room temperature to about 50° C. for 1 day to 1 week, when the pressure-sensitive adhesive layer (pressure-sensitive adhesive sheet) is prepared.

Any of various methods may be used in the step of applying the pressure-sensitive adhesive composition. Examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

In the applying step, the amount of the application is so controlled that a pressure-sensitive adhesive layer can be formed with a desired thickness (post-drying thickness). The thickness (post-drying thickness) of the pressure-sensitive adhesive layer is generally set in the range of about 1 to about 100 μm, preferably in the range of 5 to 50 μm, more preferably in the range of 10 to 40 μm.

Examples of the material used to form the release film include a plastic film such as a polyethylene, polypropylene, polyethylene terephthalate, or polyester film, a porous material such as paper, cloth, or nonwoven fabric, and appropriate thin materials such as a net, a foamed sheet, a metal foil, and a laminate thereof. A plastic film is advantageously used because of its good surface smoothness.

Such a plastic film may be of any type capable of protecting the pressure-sensitive adhesive layer. For example, such a plastic film may be a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, or an ethylene-vinyl acetate copolymer film.

The thickness of the release film is generally from about 5 to about 200 μm, preferably from about 5 to about 100 μm.

If necessary, the release film may be subjected to a release treatment and an anti-pollution treatment with a silicone, fluoride, long-chain alkyl, or fatty acid amide release agent, a silica powder or the like, or subjected to an antistatic treatment of coating type, kneading and mixing type, vapor-deposition type, or the like. In particular, when the surface of the release film is appropriately subjected to a release treatment such as a silicone treatment, a long-chain alkyl treatment, or a fluorine treatment, the releasability from the pressure-sensitive adhesive layer can be further improved.

When the pressure-sensitive adhesive layer is exposed, the pressure-sensitive adhesive layer may be protected by the release film until it is actually used. The release film may be used by itself as a separator for the pressure-sensitive adhesive-type optical film, so that the process can be simplified.

The acrylic polymer (after the crosslinking) used to form the pressure-sensitive adhesive layer preferably has a glass transition temperature (Tg) of −70 to −10° C., more preferably −70 to −20° C., even more preferably −70 to −40° C., most preferably −70 to −50° C. The acrylic polymer with a glass transition temperature of higher than −10° C. may have insufficient peel strength (adhesive strength) so that it may lift or peel during working or processing. The acrylic polymer with a glass transition temperature of lower than −70° C. may be tough to peel off in a high peel rate (tension rate) region, which may decrease work efficiency. For example, the glass transition temperature of the polymer (after the crosslinking) used to form the pressure-sensitive adhesive layer can also be controlled by the composition of the monomers in the preparation of the acrylic emulsion polymer according to the present invention.

In the present invention, the pressure-sensitive adhesive layer (a pressure-sensitive adhesive layer made from the pressure-sensitive adhesive composition of the present invention) may be provided on at least one side of a substrate (also referred to as “support” or “support substrate”) to form a pressure-sensitive adhesive sheet (a substrate-attached pressure-sensitive adhesive sheet or a pressure-sensitive adhesive sheet including a substrate and the pressure-sensitive adhesive layer provided on at least one side of the substrate). The pressure-sensitive adhesive layer may also be used by itself as a substrate-less pressure-sensitive adhesive sheet. Hereinafter, the substrate-attached pressure-sensitive adhesive sheet will also be referred to as “the pressure-sensitive adhesive sheet of the present invention.”

The pressure-sensitive adhesive sheet of the present invention (the substrate-attached pressure-sensitive adhesive sheet) can be obtained, for example, by a process including applying the pressure-sensitive adhesive composition of the present invention to at least one surface of a substrate and optionally drying the composition to form a pressure-sensitive adhesive layer on at least one side of the baking (direct coating process). Crosslinking may be performed by subjecting the pressure-sensitive adhesive sheet to heating or other processes after dehydration or drying in the drying step. Alternatively, the pressure-sensitive adhesive sheet can be obtained by a process including forming the pressure-sensitive adhesive layer temporarily on a release film and then transferring the pressure-sensitive adhesive layer onto a substrate (transfer process). As a non-limiting example, the pressure-sensitive adhesive layer is preferably formed by what is called a direct coating process, which includes applying the pressure-sensitive adhesive composition directly to the surface of a substrate.

The substrate for the pressure-sensitive adhesive sheet of the invention is preferably a plastic substrate (such as a plastic film or a plastic sheet) so that a highly transparent pressure-sensitive adhesive sheet can be obtained. Examples of materials for the plastic substrate include, but are not limited to, polyolefins (polyolefin resins) such as polypropylene and polyethylene, polyesters (polyester resins) such as polyethylene terephthalate (PET), and other transparent resins such as polycarbonate, polyamide, polyimide, acrylic, polystyrene, acetate, polyether sulfone, and triacetylcellulose. These resins may be used singly or in combination of two or more. Among the substrate materials, polyester resins or polyolefin resins are preferably used, and PET, polypropylene, and polyethylene are more preferably used in view of productivity and formability, although the substrate materials are not limited to such materials. Specifically, the substrate is preferably a polyester-based film or a polyolefin-based film, more preferably a PET film, a polypropylene film, or a polyethylene film. The polypropylene may be, but not limited to, a homopolymer (homo-type), an α-olefin random copolymer (random type), or an α-olefin block copolymer (block type). The polyethylene may be low density polyethylene (LDPE), high density polyethylene (HDPE), or linear low density polyethylene (L-LDPE). These may be used singly or in combination of two or more.

The thickness of the substrate is preferably, but not limited to, 10 to 150 μm, more preferably 30 to 100 μm.

In order to have higher adhesion to the pressure-sensitive adhesive layer, the surface of the substrate, on which the pressure-sensitive adhesive layer is to be provided, has preferably undertone an adhesion-facilitating treatment such as an acid treatment, an alkali treatment, a primer treatment, a corona treatment, a plasma treatment, or an ultraviolet ray treatment. An intermediate layer may also be provided between the substrate and the pressure-sensitive adhesive layer. The thickness of the intermediate layer is, for example, preferably from 0.01 to 1 μm, more preferably from 0.1 to 1 μm.

The pressure-sensitive adhesive sheet of the invention may be wound into a roll with the pressure-sensitive adhesive layer being protected by the release film (separator). The back surface of the pressure-sensitive adhesive sheet (the surface opposite to the side on which the pressure-sensitive adhesive layer is provided) may be subjected to a release treatment and/or an anti-pollution treatment with a silicone, fluoride, long-chain alkyl, or fatty acid amide release agent, a silica powder or the like, so that a back surface treatment layer (a release treatment layer and/or an anti-pollution treatment layer) may be provided on the back surface of the pressure-sensitive adhesive sheet. In particular, the pressure-sensitive adhesive sheet of the invention preferably has a structure of pressure-sensitive adhesive layer/substrate/back surface treatment layer.

In addition, the pressure-sensitive adhesive sheet of the invention more preferably has undergone an antistatic treatment. Such an antistatic treatment may be performed using any common antistatic treatment method such as a method of providing an antistatic layer on the back surface of the substrate (the surface opposite to the pressure-sensitive adhesive layer side) or a method of kneading a kneading-type antistatic agent into the substrate.

Examples of the method of providing an antistatic layer include a method of applying an antistatic agent, an antistatic resin composed of an antistatic agent and a resin component, a conductive resin composition containing a conductive material and a resin component, or a conductive polymer; and a method of vapor-depositing a conductive material or plating the object with a conductive material.

Examples of the antistatic agent include cationic antistatic agents such as quaternary ammonium salts, pyridinium salts, and others having a cationic functional group (such as a primary, secondary, or tertiary amino group); anionic antistatic agents such as sulfonates, sulfuric ester salts, phosphonates, phosphoric ester salts, and others having an anionic functional group; amphoteric antistatic agents such as alkylbetaine and derivatives thereof, imidazoline and derivatives thereof, and alanine and derivatives thereof; nonionic antistatic agents such as aminoalcohol and derivatives thereof, glycerin and derivatives thereof, and polyethylene glycol and derivatives thereof; and ion-conducting polymers obtained by polymerization or copolymerization of ion-conducting group-containing monomers such as the cationic, anionic, or amphoteric antistatic agents.

Specific examples of the cationic antistatic agents include alkyltrimethylammonium salts, acyloylamidopropyltrimethylammonium methosulfate, alkylbenzylmethylammonium salts, acylcholine chloride, quaternary ammonium group-containing (meth)acrylate copolymers such as polydimethylaminoethyl methacrylate, quaternary ammonium group-containing styrene copolymers such as polyvinylbenzyltrimethylammonium chloride, and quaternary ammonium group-containing diallylamine copolymers such as polydiallyldimethylammonium chloride. Examples of the anionic antistatic agents include alkylsulfonate salts, alkylbenzene sulfonate salts, alkylsulfate ester salts, alkylethoxysulfate ester salts, alkylphosphate ester salts, and sulfonic acid group-containing styrene copolymers. Examples of the amphoteric antistatic agents include alkylbetaine, alkylimidazolium betaine, and carbobetaine graft copolymers. Examples of the nonionic antistatic agents include fatty acid alkylolamide, di-(2-hydroxyethyl)alkylamine, polyoxyethylenealkylamine, fatty acid glycerin ester, polyoxyethylene glycol fatty acid ester, sorbitan fatty acid ester, polyoxysorbitan fatty acid ester, polyoxyethylene alkyl phenyl ether, polyoxyethylene alkyl ether, polyethylene glycol, polyoxyethylenediamine, a copolymer composed of polyether, polyester, and polyamide, and methoxypolyethylene glycol(meth)acrylate.

Examples of the conductive polymers include polyaniline, polypyrrole, and polythiophene.

Examples of the conductive materials include tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, and alloys or mixtures thereof.

General-purpose resin such as polyester resin, acrylic resin, polyvinyl resin, urethane resin, melamine resin, or epoxy resin may be used as the resin component. When the antistatic agent is a polymer-type antistatic agent, the antistatic resin does not need to contain the resin component. The antistatic resin may also contain, as a crosslinking agent, a methylolated or alkylolated melamine, urea, glyoxal, or acrylamide compound, an epoxy compound, or an isocyanate compound.

The antistatic layer may be formed by a coating method including diluting the antistatic resin, the conductive polymer, or the conductive resin composition with an organic solvent, water or any other solvent or dispersion medium, then applying the resulting coating liquid to a substrate, and drying the coating. Examples of the organic solvent include methyl ethyl ketone, acetone, ethyl acetate, tetrahydrofuran, dioxane, cyclohexanone, n-hexane, toluene, xylene, methanol, ethanol, n-propanol, and isopropanol. These may be used singly or in combination of two or more. The method of application may be performed using a known coating technique, examples of which include roll coating, gravure coating, reverse coating, roll brush coating, spray coating, air knife coating, impregnation, and curtain coating.

The antistatic layer formed by the coating (an antistatic resin layer, a conductive polymer layer, or a conductive resin composition layer) preferably has a thickness of 0.001 to 5 μm, more preferably 0.005 to 1 μm.

Methods for vapor-deposition of the conductive material and methods for plating with the conductive material include vacuum deposition, sputtering, ion plating, chemical vapor deposition, spray pyrolysis, chemical plating, and electroplating.

The antistatic layer (conductive material layer) formed by the vapor deposition or plating preferably has a thickness of 20 to 10,000 Å (0.002 to 1 μm), more preferably 50 to 5,000 Å (0.005 to 0.5 μm).

Any of the above antistatic agents may be appropriately used as the kneading-type antistatic agent. The content of the kneading-type antistatic agent is preferably 20% by weight or less, more preferably 0.05 to 10% by weight, based on the total weight of the substrate (100% by weight). The kneading method may be any method capable of uniformly mixing the kneading-type antistatic agent into, for example, a resin for use in the plastic substrate. Examples generally include methods using a heating roll, a Banbury mixer, a pressure kneader, a biaxial kneading machine, etc.

The removable water-dispersible acrylic pressure-sensitive adhesive composition of the present invention is superior in antistatic properties, adhesive properties (adhesion), removal stability, and removability (light peelability or easy peelability), can form a removable pressure-sensitive adhesive layer, and is suitable for use in forming a pressure-sensitive adhesive layer for removable applications. Specifically, the pressure-sensitive adhesive sheet having the pressure-sensitive adhesive layer is preferably used for removable applications (e.g., masking tapes such as masking tapes for building curing, masking tapes for automobile painting, masking tapes for electronic components (such as lead frames and printed boards), and masking tapes for sandblasting; surface protection films such as surface protection films for aluminum sashes, surface protection films for optical plastics, surface protection films for optical glass products, surface protection films for automobile protection, and surface protection films for metal plates; pressure-sensitive adhesive tapes for use in semiconductor and electronic component processes, such as back grinding tapes, pellicle fixing tapes, dicing tapes, lead frame fixing tapes, cleaning tapes, dust removing tapes, carrier tapes, and cover tapes; tapes for packing electronic devices or electronic components; tapes for temporary bonding during transportation; binding tapes; and labels).

When attached to and used on an adherend, the pressure-sensitive adhesive layer (pressure-sensitive adhesive sheet) made from the removable water-dispersible acrylic pressure-sensitive adhesive composition of the present invention does not cause the adherend to suffer from staining such as white staining and is highly less-staining. Appearance defects such as dents are also reduced in the pressure-sensitive adhesive layer (pressure-sensitive adhesive sheet), which, therefore, has good appearance characteristics. Thus, the pressure-sensitive adhesive sheet of the present invention is advantageously used in surface protection applications (such as surface protecting films for use on optical members), requiring less-staining properties, for optical members (such as optical plastics, optical glass products, and optical films) such as polarizing plates, retardation plates, anti-reflection plates, wavelength plates, optical compensation films, and brightness enhancement films for constituting panels for liquid crystal displays, organic electroluminescence (organic EL) displays, field emission displays, and other displays. It will be understood that such applications are non-limiting and that there are other applications such as surface protection and breakage prevention during the manufacture of fine-processed products such as semiconductors, circuits, a variety of printed boards, a variety of masks, and lead frames, removal of foreign bodies and the like, and masking.

### EXAMPLES

Hereinafter, the invention will be more specifically described with reference to examples, which however are not intended to limit the invention. In the description below, “parts” and “%” are by weight unless otherwise specified.

### Example 1-1

### Preparation of Acrylic Emulsion Polymer

To a vessel were added 90 parts by weight of water and 96 parts by weight of 2-ethylhexyl acrylate (2EHA), 4 parts by weight of acrylic acid (AA), and 3 parts by weight of a reactive nonionic-anionic emulsifier (AQUALON HS-1025 (trade name) manufactured by Dai-ichi Kogyo Seiyaku Co., Ltd.) as shown in Table 1 and then mixed by stirring with a homomixer to form a monomer emulsion.

A reaction vessel equipped with a condenser tube, a nitrogen-introducing tube, a thermometer, and a stirrer was then charged with 50 parts by weight of water, 0.01 parts by weight of a polymerization initiator (ammonium persulfate), and 10% by weight part of the monomer emulsion. The mixture was subjected to emulsion polymerization at 65° C. for 1 hour with stirring. Subsequently, after 0.05 parts by weight of a polymerization initiator (ammonium persulfate) was further added, all the remaining part (90% by weight part) of the monomer emulsion was added over 3 hours with stirring. The mixture was then subjected to reaction at 75° C. for 3 hours. Subsequently, after the reaction mixture was cooled to 30° C., 10% by weight ammonia water was added to adjust its pH to 8, so that a water dispersion of an acrylic emulsion polymer (41% by weight in acrylic emulsion polymer concentration) was obtained.

### (Preparation of Removable Water-Dispersible Acrylic Pressure-Sensitive Adhesive Composition)

Based on 100 parts by weight (solid basis) of the acrylic emulsion polymer, 2.5 parts by weight of an epoxy crosslinking agent (TETRAD-C (trade name) manufactured by MITSUBISHI GAS CHEMICAL COMPANY, INC., 1,3-bis(N,N-diglycidylaminomethyl)cyclohexane, 110 in epoxy equivalent, 4 in the number of functional groups) as a non-water-soluble crosslinking agent, 1 part by weight of a non-water-soluble ionic liquid (IL-110 (trade name) manufactured by Dai-ichi Kogyo Seiyaku Co., Ltd., 1-ethyl-3-methylimidazolium bis(fluorosulfonyl)imide), and 0.5 parts by weight of a polyether antifoamer (ADEKA PLURONIC 25R-1 (trade name) manufactured by ADEKA CORPORATION (2,800 in number average molecular weight, 90% by weight in PO content)) were mixed into the water dispersion of the acrylic emulsion polymer by stirring with a mixer under the stirring conditions of 23° C., 300 rpm, and 10 minutes to form a removable water-dispersible acrylic pressure-sensitive adhesive composition.

### (Formation of Pressure-Sensitive Adhesive Layer and Preparation of Pressure-Sensitive Adhesive Sheet)

Using an applicator manufactured by TESTER SANGYO CO., LTD., the removable water-dispersible acrylic pressure-sensitive adhesive composition was applied (coated) onto the corona-treated surface of a PET film (E7415 (trade name) manufactured by TOYOBO CO., LTD., 38 μm in thickness) so that a 15-μm-thick coating would be formed after drying. Subsequently, the coated film was dried at 120° C. for 2 minutes in a hot air circulating oven and then aged at room temperature for 1 week to give a pressure-sensitive adhesive sheet.

### Examples 1-2 to 1-7 and Comparative Examples 1-1 to 1-3

Monomer emulsions were prepared as in Example 1-1, except that the type of the raw material monomers, the emulsifier, and other materials, the content of the materials, and other conditions were changed as shown in Tables 1 and 2. Using the monomer emulsions, removable water-dispersible acrylic pressure-sensitive adhesive compositions and pressure-sensitive adhesive sheets were obtained as in Example 1-1.

### [Evaluations]

The water-dispersible acrylic pressure-sensitive adhesive compositions and the pressure-sensitive adhesive sheets obtained in the examples and the comparative examples were evaluated using the measurement method or the evaluation method described below. Tables 1 and 2 show the results of the evaluation.

### (1) Peeling Electrification Voltage

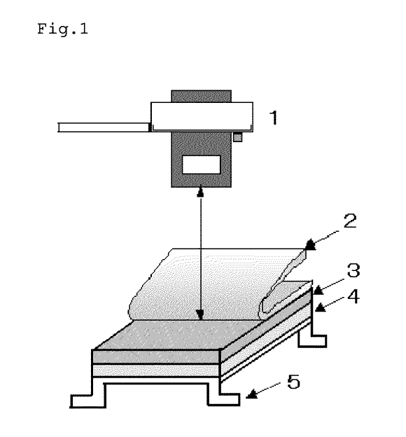

The prepared pressure-sensitive adhesive sheet was cut into a piece with a size of 70 mm in width and 130 mm in length, and the separator was peeled off. An acrylic plate (ACRYLITE manufactured by Mitsubishi Rayon Co., Ltd, 1 mm thick, 70 mm wide, and 100 mm long) was subjected to static elimination in advance, and a polarizing plate (SEG1425DU (trade name) manufactured by NITTO DENKO CORPORATION) was then bonded to the acrylic plate. Using a hand roller, the piece was then pressure-bonded to the surface of the polarizing plate in such away that one end of the piece protruded 30 mm out of the plate. Subsequently, the resulting sample was allowed to stand in an environment at 23° C. and 24±2% RH for a day and then set at a predetermined location as shown in FIG. 1. The one end protruding 30 mm was fixed to an automatic winder, and the piece was peeled off at a peel angle of 150° and a peeling rate of 10 m/minute. In this operation, the electrical potential generated on the surface of the polarizing plate was measured using a potential meter (KSD-0103 manufactured by KASUGA ELECTRIC WORKS LTD.) fixed at a predetermined position. The distance between the sample and the potential meter was 100 mm during the measurement on the surface of the acrylic plate. The measurement was performed in an environment at 23° C. and 2 4±2% RH.

The pressure-sensitive adhesive sheet of the present invention preferably has a peeling electrification voltage (absolute value) of 1.0 kV or less, more preferably 0.5 kV or less. A peeling electrification voltage of more than 1.0 kV can disturb the orientation of a polarizer in a polarizing plate, which is not preferred.

### (2) Adhesive Strength (Peel Strength)

The prepared pressure-sensitive adhesive sheet was cut into a piece with a size of 25 mm in width and 100 mm in length, and the separator was peeled off. Using a laminator (Compact Laminator manufactured by TESTER SANGYO CO., LTD.), the resulting piece was then laminated onto a polarizing plate (SEG1425DU manufactured by NITTO DENKO CORPORATION, 70 mm wide, 100 mm long) under the conditions of 0.25 MPa and 0.3 m/minute to form an evaluation sample.

After the lamination, the sample was allowed to stand in an environment at 23° C. and 50% RH for 30 minutes and then measured for adhesive strength (N/25 mm) at a peel angle of 180° and a peeling rate of 30 m/minute using a universal tensile tester. The measurement was performed in an environment at 23° C. and 50% RH.

The pressure-sensitive adhesive sheet of the present invention preferably has an adhesive strength (peel strength) of 0.1 to 0.8 N/25 mm, more preferably 0.2 to 0.7 N/25 mm, even more preferably 0.2 to 0.6 N/25 mm, further more preferably 0.2 to 0.5 N/25 mm. The pressure-sensitive adhesive sheet with an adhesive strength of 0.8 N/25 mm or less is preferable in that it can be easily peeled off (light peelability) to make productivity or handleability higher in the process of manufacturing polarizing plates or liquid crystal display devices. The pressure-sensitive adhesive sheet with an adhesive strength of 0.1 N/25 mm or more is preferable in that it can be prevented from lifting or peeling in manufacturing processes and can sufficiently function as a surface protecting sheet.

### (3) Less-Staining Properties (White Staining) [Humidity Test]

Using a laminator (Compact Laminator manufactured by TESTER SANGYO CO., LTD.), the pressure-sensitive adhesive sheet (sample size: 25 mm wide and 100 mm long) obtained in each of the examples and the comparative examples was laminated onto a polarizing plate (SEG1425DU (trade name) manufactured by NITTO DENKO CORPORATION, size: 70 mm wide and 120 mm long) under the conditions of 0.25 MPa and 0.3 m/minute.

The laminate composed of the polarizing plate and the pressure-sensitive adhesive sheet bonded thereto was allowed to stand at 80° C. for 4 hours, and then the pressure-sensitive adhesive sheet was peeled off. The polarizing plate obtained by peeling off the pressure-sensitive adhesive sheet was then allowed to stand in a humidified environment (23° C., 90% RH) for 12 hours. The surface of the polarizing plate was then visually observed and evaluated for less-staining properties according to the criteria shown below. If white staining occurs on the polarizing plate as the adherend under the humidified conditions (high-humidity conditions) after the bonding and peeling off of the pressure-sensitive adhesive sheet, the less-staining properties of the pressure-sensitive adhesive sheet can be judged to be not enough for optical member surface-protecting film applications.

Good level of less-staining properties (o): No change was observed in the part where the pressure-sensitive adhesive sheet had been bonded and in the part where it had not been bonded.

Poor level of less-staining properties (x): White staining was observed in the part where the pressure-sensitive adhesive sheet had been bonded.

TABLE 1

| | | | Example | | | | | | |
|---|---|---|---|---|---|---|---|---|---|
| Components and evaluation results | | | 1-1 | 1-2 | 1-3 | 1-4 | 1-5 | 1-6 | 1-7 |
| Acrylic | Raw material | 2EHA | 96 | 96 | 96 | 96 | 96 | 96 | 96 |
| emulsion | monomers | AA | 4 | 4 | 4 | 4 | 4 | 4 | 4 |
| polymer | Emulsifier | HS-1025 | 3 | 3 | 3 | 3 | 3 | 3 | 3 |
| Removable | Acrylic emulsion polymer | | 100 | 100 | 100 | 100 | 100 | 100 | 100 |
| water- | Non-water-soluble | TETRAD-C | 2.5 | 2.5 | 2.5 | 2.5 | 2.5 | 2.5 | 2.5 |
| dispersible | crosslinking agent | | | | | | | | |
| acrylic | Ionic liquid | IL-110 | 1 | | | | | 0.5 | 0.5 |
| pressure- | | IL-120 | | 1 | | | | | |
| sensitive | | IL-130 | | | 1 | | | | |
| adhesive | | IL-210 | | | | 1 | | | |
| composition | | IL-230 | | | | | 1 | | |
| | Polyether | 25R-1 | 0.5 | 0.5 | 0.5 | 0.5 | 0.5 | | |
| | antifoamer | 25R-2 | | | | | | | 1 |
| | | P-84 | | | | | | 1 | |
| | Modified silicone | 1316 | | | | | | | |
| | antifoamer | | | | | | | | |
| Pressure- | Peeling | Peeling | 0.0 | 0.0 | 0.0 | 0.0 | 0.0 | 0.0 | 0.1 |
| sensitive | electrification | rate | | | | | | | |
| adhesive | voltage (kV) | 30 m/min | | | | | | | |
| sheet | Adhesive strength | Peeling | 0.4 | 0.4 | 0.4 | 0.4 | 0.4 | 0.3 | 0.3 |
| | (N/25 mm) | rate | | | | | | | |
| | | 30 m/min | | | | | | | |

| | | | | | | | |
|---|---|---|---|---|---|---|---|
| Appearance | ∘ | ∘ | ∘ | ∘ | ∘ | ∘ | ∘ |
| Less-staining properties | ∘ | ∘ | ∘ | ∘ | ∘ | ∘ | ∘ |

TABLE 2

| | | | Comparative Example | | |
|---|---|---|---|---|---|
| Components and evaluation results | | | 1-1 | 1-2 | 1-3 |
| Acrylic | Raw material monomers | 2EHA | 96 | 96 | 96 |
| emulsion | | AA | 4 | 4 | 4 |
| polymer | Emulsifier | HS-1025 | 3 | 3 | 3 |
| Removable | Acrylic emulsion polymer | | 100 | 100 | 100 |
| water-dispersible | Non-water-soluble | TETRAD-C | 2.5 | 2.5 | 2.5 |
| acrylic | crosslinking agent | | | | |
| pressure-sensitive | Ionic liquid | IL-110 | | 0.5 | 0.5 |
| adhesive | | IL-120 | | | |
| composition | | IL-130 | | | |
| | | IL-210 | | | |
| | | IL-230 | | | |
| | Polyether antifoamer | 25R-1 | | | |
| | | 25R-2 | | | |
| | | P-84 | | | |
| | Modified silicone | 1316 | | | 1.0 |
| | antifoamer | | | | |
| Pressure- | Peeling | Peeling | 2.1 | 0.6 | Appearance |
| sensitive | electrification | rate | | | not |
| adhesive | voltage (kV) | 30 m/min | | | evaluated |
| sheet | | | | | (X) |
| | Adhesive strength | Peeling | 0.6 | 0.6 | 0.6 |
| | (N/25 mm) | rate | | | |
| | | 30 m/min | | | |

| | | | |
|---|---|---|---|
| Appearance | X | X | X |
| Less-staining properties | ◯ | Appearance | Appearance |
| | | not | not |
| | | evaluated | evaluated |
| | | (X) | (X) |

In Tables 1 and 2, the weight of the solid is shown with respect to each component. Herein, the following abbreviations are used in Tables 1 and 2.

2EHA: 2-ethylhexyl acrylate

AA: Acrylic acid

HS-1025: AQUALON HS-1025 (trade name) manufactured by Dai-ichi Kogyo Seiyaku Co., Ltd. (a reactive nonionic-anionic emulsifier)

TETRAD-C: TETRAD-C (trade name) manufactured by MITSUBISHI GAS CHEMICAL COMPANY, INC. (1,3-bis(N,N-diglycidylaminomethyl)cyclohexane, 110 in epoxy equivalent, 4 in the number of functional groups) (a non-water-soluble crosslinking agent)

IL-110: 1-ethyl-3-methylimidazolium bis(fluorosulfonyl)imide (non-water-soluble) manufactured by Dai-ichi Kogyo Seiyaku Co., Ltd.

IL-120: 1-methyl-1-propylpyrrolidinium bis(fluorosulfonyl)imide (non-water-soluble) manufactured by Dai-ichi Kogyo Seiyaku Co., Ltd.

IL-130: 1-methyl-1-propylpiperidinium bis(fluorosulfonyl)imide (non-water-soluble) manufactured by Dai-ichi Kogyo Seiyaku Co., Ltd.

IL-210: 1-ethyl-3-methylimidazolium bis(trifluoromethylsulfonyl)imide (non-water-soluble) manufactured by Dai-ichi Kogyo Seiyaku Co., Ltd.

IL-230: 1-methyl-1-propylpiperidinium bis(trifluoromethylsulfonyl)imide (non-water-soluble) manufactured by Dai-ichi Kogyo Seiyaku Co., Ltd.

25R-1: ADEKA PLURONIC 25R-1 (trade name) manufactured by ADEKA CORPORATION (a polyether antifoamer, 90% by weight in PO content, 2,800 in number average molecular weight)

25R-2: ADEKA PLURONIC 25R-2 (trade name) manufactured by ADEKA CORPORATION (a polyether antifoamer, 80% by weight in PO content, 3,000 in number average molecular weight)

P-84: ADEKA PLURONIC P-84 (trade name) manufactured by ADEKA CORPORATION (a polyether antifoamer, 60% by weight in PO content, 3,750 in number average molecular weight)

1316: SN-Defoamer 1316 (trade name) manufactured by SAN NOPCO LIMITED (a modified silicone antifoamer)

From the evaluation results in Table 1, it has been found that in all the examples, the resulting pressure-sensitive adhesive layers (pressure-sensitive adhesive sheets) are superior not only in antistatic properties, removability (light peelability), and appearance, but also in less-staining properties on adherends, especially, the ability to prevent white staining on adherends in a high-humidity environment (the ability to prevent white staining).

On the other hand, the evaluation results in Table 2 show as follows. In Comparative Examples 1-1 to 1-3, the appearance was poor. Particularly in Comparative Example 1-1 where the non-water-soluble (hydrophobic) ionic liquid as an antistatic agent was not added, the peeling electrification voltage was very high, and antistatic properties were not obtained. In Comparative Example 1-2, the peeling electrification voltage was high although the non-water-soluble (hydrophobic) ionic liquid was added. This has been found to be because no polyether antifoamer is added so that static build-up on the non-antistatic adherend (object to be protected) is not sufficiently prevented during the peeling off process. It has also been found that in Comparative Example 1-3, the modified silicone antifoamer used has a low surface tension and thus can have an adverse effect on the appearance characteristics.

### Example 2-1

### Preparation of Acrylic Emulsion Polymer

To a vessel were added 90 parts by weight of water and 96 parts by weight of 2-ethylhexyl acrylate (2EHA), 4 parts by weight of acrylic acid (AA), and 3 parts by weight of a reactive nonionic-anionic emulsifier (AQUALON HS-1025 (trade name) manufactured by Dai-ichi Kogyo Seiyaku Co., Ltd.) as shown in Table 3 and then mixed by stirring with a homomixer to form a monomer emulsion.

A reaction vessel equipped with a condenser tube, a nitrogen-introducing tube, a thermometer, and a stirrer was then charged with 50 parts by weight of water, 0.01 parts by weight of a polymerization initiator (ammonium persulfate), and 10% by weight part of the monomer emulsion. The mixture was subjected to emulsion polymerization at 65° C. for 1 hour with stirring. Subsequently, after 0.05 parts by weight of a polymerization initiator (ammonium persulfate) was further added, all the remaining part (90% by weight part) of the monomer emulsion was added over 3 hours with stirring. The mixture was then subjected to reaction at 75° C. for 3 hours. Subsequently, after the reaction mixture was cooled to 30° C., 10% by weight ammonia water was added to adjust its pH to 8, so that a water dispersion of an acrylic emulsion polymer (41% by weight in acrylic emulsion polymer concentration) was obtained.

### (Preparation of Water-Dispersible Acrylic Pressure-Sensitive Adhesive Composition)

Based on 100 parts by weight (solid basis) of the acrylic emulsion polymer, 2 parts by weight of an epoxy crosslinking agent (TETRAD-C (trade name) manufactured by MITSUBISHI GAS CHEMICAL COMPANY, INC., 1,3-bis(N,N-diglycidylaminomethyl)cyclohexane, 110 in epoxy equivalent, 4 in the number of functional groups) as a non-water-soluble crosslinking agent, 0.5 parts by weight of 3-butyl-3-methylpyrrolidinium trifluoromethanesulfonate (100% by weight in active component content), and 5 parts by weight of a polyether antifoamer (ADEKA PLURONIC 25R-1 (trade name) manufactured by ADEKA CORPORATION (a block copolymer of EO and PO, 2,800 in number average molecular weight, 90% by weight in PO content)) were mixed into the water dispersion of the acrylic emulsion polymer by stirring with a mixer under the stirring conditions of 23° C., 300 rpm, and 10 minutes to form a water-dispersible acrylic pressure-sensitive adhesive composition.

### (Formation of Pressure-Sensitive Adhesive Layer and Preparation of Pressure-Sensitive Adhesive Sheet)

Using an applicator manufactured by TESTER SANGYO CO., LTD., the water-dispersible acrylic pressure-sensitive adhesive composition was applied (coated) onto the corona-treated surface of a PET film (E7415 (trade name) manufactured by TOYOBO CO., LTD., 38 μm in thickness) so that a 15-μm-thick coating would be formed after drying. Subsequently, the coated film was dried at 120° C. for 2 minutes in a hot air circulating oven and then aged at room temperature for 1 week to give a pressure-sensitive adhesive sheet.

### Examples 2-2 to 2-9 and Comparative Examples 2-1 to 2-5

Monomer emulsions were prepared as in Example 2-1, except that the type and content of the raw material monomers and other conditions were changed as shown in Tables 3 and 4. In the preparation, the additives not shown in the tables were used in the same amounts as those in Example 2-1. Using the monomer emulsions, water-dispersible acrylic pressure-sensitive adhesive compositions and pressure-sensitive adhesive sheets were obtained as in Example 2-1.

### [Evaluations]

The water-dispersible acrylic pressure-sensitive adhesive compositions and the pressure-sensitive adhesive sheets obtained in the examples and the comparative examples were evaluated using the measurement method or the evaluation method described below. Tables 3 and 4 show the results of the evaluation.

### (1) Peeling Electrification Voltage

The prepared pressure-sensitive adhesive sheet was cut into a piece with a size of 70 mm in width and 130 mm in length, and the separator was peeled off. An acrylic plate (ACRYLITE manufactured by Mitsubishi Rayon Co., Ltd, 1 mm thick, 70 mm wide, and 100 mm long) was subjected to static elimination in advance, and a polarizing plate (SEG1425DU (trade name) manufactured by NITTO DENKO CORPORATION) was then bonded to the acrylic plate. Using a hand roller, the piece was then pressure-bonded to the surface of the polarizing plate in such a way that one end of the piece protruded 30 mm out of the plate. Subsequently, the resulting sample was allowed to stand in an environment at 23° C. and 24±2% RH for a day and then set at a predetermined location as shown in FIG. 1. The one end protruding 30 mm was fixed to an automatic winder, and the piece was peeled off at a peel angle of 150° and a peeling rate of 10 m/minute. In this operation, the electrical potential generated on the surface of the polarizing plate was measured using a potential meter (KSD-0103 manufactured by KASUGA ELECTRIC WORKS LTD.) fixed at a predetermined position. The distance between the sample and the potential meter was 100 mm during the measurement on the surface of the acrylic plate. Herein, the measurement was performed in an environment at 23° C. and 24±2% RH.

The pressure-sensitive adhesive sheet of the present invention preferably has a peeling electrification voltage (absolute value) of 1.0 kV or less, more preferably 0.5 kV or less. A peeling electrification voltage of more than 1.0 kV can disturb the orientation of liquid crystals, which is not preferred.

### (2) Appearance (Presence or Absence of Dent)

In the pressure-sensitive adhesive sheet obtained in each of the examples and the comparative examples, the state of the pressure-sensitive adhesive layer surface was visually observed. How many defects (dents) were present in an observed area of 10 cm long and 10 mm wide was measured and evaluated according to the criteria shown below.

0 to 100 defects: good appearance (o)

101 or more defects: poor appearance (x)

TABLE 3

| | | | Example | | | | | | | | |
|---|---|---|---|---|---|---|---|---|---|---|---|
| Components and evaluation results | | | 2-1 | 2-2 | 2-3 | 2-4 | 2-5 | 2-6 | 2-7 | 2-8 | 2-9 |
| Acrylic | Monomer | 2EHA | 96 | 96 | 96 | 96 | 96 | 96 | 96 | 96 | 96 |
| emulsion | components | AA | 4 | 4 | 4 | 4 | 4 | 4 | 4 | 4 | 4 |
| polymer | | nBA | | | | | | | | | |
| (parts by | Reactive | HS-1025 | 3 | 3 | 3 | 3 | 3 | 3 | 3 | 3 | 3 |
| weight) | emulsifier | | | | | | | | | | |
| Pressure- | Acrylic emulsion polymer | | 100 | 100 | 100 | 100 | 100 | 100 | 100 | 100 | 100 |
| sensitive | Non-water- | T/C | 2.5 | 2.5 | 2.5 | 2.5 | 2.5 | 2.5 | 2.5 | 2.5 | 2.5 |
| adhesive | soluble | | | | | | | | | | |
| composition | crosslinking | | | | | | | | | | |
| (parts by | agent | | | | | | | | | | |
| weight) | Water-soluble | WS-500 | | | | | | | | | |
| | crosslinking | | | | | | | | | | |
| | agent | | | | | | | | | | |
| | Water-soluble | CIL-313 | 0.5 | | | | | | | | |
| | ionic liquid | EtMePy-EF11 | | | | | | | | 0.5 | |
| | | EtMePy-EF21 | | | | | | | | | 1 |
| | | EMI-EF31 | | 1 | | 1 | | 1 | | | |
| | | EMI-EF11 | | | 1 | | 1 | | 1 | | |
| | Polyether | 25R-1 | 5 | 3 | 1 | | | | | | 1 |
| | antifoamer | 25R-2 | | | | 1 | 1 | | | | |
| | | 17R-4 | | | | | | 1 | 1 | | |
| | | 17R-2 | | | | | | | | | |
| | | P-84 | | | | | | | | 1 | |
| Pressure- | Peeling | Absolute | 0.1 | 0.0 | 0.2 | 0.1 | 0.1 | 0.0 | 0.0 | 0.1 | 0.3 |
| sensitive | electrification | value (kV) | | | | | | | | | |
| adhesive | voltage | at peeling | | | | | | | | | |
| sheet | | rate | | | | | | | | | |
| | | 30 m/min | | | | | | | | | |

| | | | | | | | | | |
|---|---|---|---|---|---|---|---|---|---|
| Appearance | ∘ | ∘ | ∘ | ∘ | ∘ | ∘ | ∘ | ∘ | ∘ |

TABLE 4

| | | | Comparative Example | | | | |
|---|---|---|---|---|---|---|---|
| Components and evaluation results | | | 2-1 | 2-2 | 2-3 | 2-4 | 2-5 |
| Acrylic emulsion | Monomer | 2EHA | 96 | 96 | 96 | | 85 |
| polymer (parts | components | AA | 4 | 4 | 4 | 4 | 15 |
| by weight) | | nBA | | | | 96 | |
| | Reactive | HS-1025 | 3 | 3 | 3 | 3 | 3 |
| | emulsifier | | | | | | |
| Pressure- | Acrylic emulsion polymer | | 100 | 100 | 100 | 100 | Pressure-sensitive |
| sensitive | Non-water-soluble | T/C | 2.5 | 2.5 | 2.5 | | adhesive sheet was |
| adhesive | crosslinking | | | | | | not able to be |
| composition | agent | | | | | | prepared due to |
| (parts by | Water-soluble | WS-500 | | | | 5 | formation of |
| weight) | crosslinking | | | | | | aggregate during |
| | agent | | | | | | preparation of |
| | Water-soluble | CIL-313 | 1 | | | 4.5 | acrylic emulsion |
| | ionic liquid | EtMePy-EF11 | | | | | polymer. |
| | | EtMePy-EF21 | | | | | |
| | | EMI-EF31 | | | | | |
| | | EMI-EF11 | | | | | |
| | Polyether | 25R-1 | | | 1 | | |
| | antifoamer | 25R-2 | | | | | |
| | | 17R-4 | | | | | |
| | | 17R-2 | | | | | |
| | | P-84 | | | | | |
| Pressure-sensitive | Peeling | Absolute | 1.6 | 2.1 | 2.1 | 0.0 | |
| adhesive sheet | electrification | value (kV) | | | | | |
| | voltage | at peeling | | | | | |
| | | rate 30 | | | | | |
| | | m/min | | | | | |

| | | | | |
|---|---|---|---|---|
| Appearance | x | x | ∘ | x |

In Tables 3 and 4, the weight of the solid is shown with respect to each component. Herein, the following abbreviations are used in Tables 3 and 4.

2EHA: 2-ethylhexyl acrylate

nBA: n-butyl acrylate

AA: Acrylic acid

HS-1025: AQUALON HS-1025 (trade name) manufactured by Dai-ichi Kogyo Seiyaku Co., Ltd. (a reactive nonionic-anionic emulsifier)

T/C: TETRAD-C (trade name) manufactured by MITSUBISHI GAS CHEMICAL COMPANY, INC. (1,3-bis(N,N-diglycidylaminomethyl)cyclohexane, 110 in epoxy equivalent, 4 in the number of functional groups) (a non-water-soluble crosslinking agent)

WS-500: EPOCROS WS-500 (trade name) manufactured by NIPPON SHOKUBAI CO., LTD. (a water-soluble crosslinking agent, 220 in oxazoline equivalent)

CIL-313: N-butyl-3-methylpyridinium trifluoromethanesulfate (water-soluble) manufactured by Japan Carlit Co., Ltd.

EtMePy-EF11: N-ethyl-3-methylpyridinium trifluoromethanesulfonate (water-soluble) manufactured by Mitsubishi Materials Corporation

EtMePy-EF21: N-ethyl-3-methylpyridinium perfluoroethanesulfonate (water-soluble) manufactured by Mitsubishi Materials Corporation

EtMePy-EF31: N-ethyl-3-methylpyridinium perfluoropropanesulfonate (water-soluble) manufactured by Mitsubishi Materials Corporation

EMI-EF31: N-ethyl-3-methylimidazolium perfluoropropanesulfonate (water-soluble) manufactured by Mitsubishi Materials Corporation

EMI-EF11: N-ethyl-3-methylimidazolium trifluoromethanesulfonate (water-soluble) manufactured by Mitsubishi Materials Corporation

25R-1: ADEKA PLURONIC 25R-1 (trade name) manufactured by ADEKA CORPORATION (a polyether antifoamer, 2,800 in number average molecular weight, 90% by weight in PO content)

25R-2: ADEKA PLURONIC 25R-2 (trade name) manufactured by ADEKA CORPORATION (a polyether antifoamer, 3,000 in number average molecular weight, 80% by weight in PO content)

17R-4: ADEKA PLURONIC 17R-4 (trade name) manufactured by ADEKA CORPORATION (a polyether antifoamer, 2,500 in number average molecular weight, 60% by weight in PO content)

17R-2: ADEKA PLURONIC 17R-2 (trade name) manufactured by ADEKA CORPORATION (a polyether antifoamer, 2,000 in number average molecular weight, 80% by weight in PO content)

P-84: ADEKA PLURONIC P-84 (trade name) manufactured by ADEKA CORPORATION (a polyether antifoamer, 3,750 in number average molecular weight, 60% by weight in PO content)

From the results in Table 3, it has been found that even under high-speed peeling conditions (a peeling rate of 30 m/minute), the pressure-sensitive adhesive sheets of all the examples are superior not only in removal stability and antistatic properties but also in appearance characteristics.

On the other hand, the results in Table 4 show as follows. In Comparative Example 2-1 where no polyether antifoamer was added, poor appearance characteristics were obtained, and at the same time, poor removal stability and insufficient antistatic properties were obtained. In Comparative Example 2-2 where neither polyether antifoamer nor ionic liquid as an antistatic agent was added, poor appearance characteristics were obtained, and the peeling electrification voltage was very high, so that no antistatic properties were obtained. In Comparative Example 2-3 where no ionic liquid was added, no antistatic properties were obtained. In comparative Example 2-4 where no polyether antifoamer was added, the resulting appearance characteristics were poor. In Comparative Example 2-5 where the content of the carboxyl group-containing unsaturated monomer (acrylic acid) was too high, the pressure-sensitive adhesive sheet was not able to be prepared due to the formation of an aggregate in the process of preparing the acrylic emulsion polymer.

### Example 3-1

### Preparation of Acrylic Emulsion Polymer

To a vessel were added 90 parts by weight of water and 96 parts by weight of 2-ethylhexyl acrylate (2EHA), 4 parts by weight of acrylic acid (AA), and 3 parts by weight of a reactive nonionic-anionic emulsifier (AQUALON HS-1025 (trade name) manufactured by Dai-ichi Kogyo Seiyaku Co., Ltd.) as shown in Table 5 and then mixed by stirring with a homomixer to form a monomer emulsion.

A reaction vessel equipped with a condenser tube, a nitrogen-introducing tube, a thermometer, and a stirrer was then charged with 50 parts by weight of water, 0.01 parts by weight of a polymerization initiator (ammonium persulfate), and 10% by weight part of the monomer emulsion. The mixture was subjected to emulsion polymerization at 65° C. for 1 hour with stirring. Subsequently, after 0.05 parts by weight of a polymerization initiator (ammonium persulfate) was further added, all the remaining part (90% by weight part) of the monomer emulsion was added over 3 hours with stirring. The mixture was then subjected to reaction at 75° C. for 3 hours. Subsequently, after the reaction mixture was cooled to 30° C., 10% by weight ammonia water was added to adjust its pH to 8, so that a water dispersion of an acrylic emulsion polymer (41% by weight in acrylic emulsion polymer concentration) was obtained.

### (Preparation of Removable Water-Dispersible Acrylic Pressure-Sensitive Adhesive Composition)

Based on 100 parts by weight (solid basis) of the acrylic emulsion polymer, 2 parts by weight of an epoxy crosslinking agent (TETRAD-C (trade name) manufactured by MITSUBISHI GAS CHEMICAL COMPANY, INC., 1,3-bis(N,N-diglycidylaminomethyl)cyclohexane, 110 in epoxy equivalent, 4 in the number of functional groups) as a non-water-soluble crosslinking agent, 2 parts by weight of lithium trifluoromethanesulfonate (in the form of a 50% by weight aqueous solution), and 1 part by weight of a polyether antifoamer (ADEKA PLURONIC 17R-4 (trade name) manufactured by ADEKA CORPORATION (2,500 in number average molecular weight, 40% by weight in EO content)) were mixed into the water dispersion of the acrylic emulsion polymer by stirring with a mixer under the stirring conditions of 23° C., 300 rpm, and 10 minutes to form a removable water-dispersible acrylic pressure-sensitive adhesive composition.

### (Formation of Pressure-Sensitive Adhesive Layer and Preparation of Pressure-Sensitive Adhesive Sheet)

Using an applicator manufactured by TESTER SANGYO CO., LTD., the removable water-dispersible acrylic pressure-sensitive adhesive composition was applied (coated) onto the corona-treated surface of a PET film (E7415 (trade name) manufactured by TOYOBO CO., LTD., 38 μm in thickness) so that a 15-μm-thick coating would be formed after drying. Subsequently, the coated film was dried at 120° C. for 2 minutes in a hot air circulating oven and then aged at room temperature for 1 week to give a pressure-sensitive adhesive sheet.

### Examples 3-2 to 3-5 and Comparative Examples 3-1 to 3-6

Monomer emulsions were prepared as in Example 3-1, except that the type and content of the raw material monomers and other conditions were changed as shown in Table 5. In the preparation, the additives not shown in the table were used in the same amounts as those in Example 3-1. In Comparative Example 3-3, polyethylene glycol (2,000 in number average molecular weight) was used instead of the polyether antifoamer. Also, using the monomer emulsions, removable water-dispersible acrylic pressure-sensitive adhesive compositions and pressure-sensitive adhesive sheets were obtained as in Example 3-1.

### [Evaluations]

The water-dispersible acrylic pressure-sensitive adhesive compositions and the pressure-sensitive adhesive sheets obtained in the examples and the comparative examples were evaluated using the measurement method or the evaluation method described below. Table 5 shows the results of the evaluation.

### (1) Peeling Electrification Voltage

The prepared pressure-sensitive adhesive sheet was cut into a piece with a size of 70 mm in width and 130 mm in length, and the separator was peeled off. An acrylic plate (ACRYLITE manufactured by Mitsubishi Rayon Co., Ltd, 1 mm thick, 70 mm wide, and 100 mm long) was subjected to static elimination in advance, and a polarizing plate (SEG1425DU (trade name) manufactured by NITTO DENKO CORPORATION) was then bonded to the acrylic plate. Using a hand roller, the piece was then pressure-bonded to the surface of the polarizing plate in such a way that one end of the piece protruded 30 mm out of the plate. Subsequently, the resulting sample was allowed to stand in an environment at 23° C. and 24±2% RH for a day and then set at a predetermined location as shown in FIG. 1. The one end protruding 30 mm was fixed to an automatic winder, and the piece was peeled off at a peel angle of 150° and a peeling rate of 10 m/minute. In this operation, the electrical potential generated on the surface of the polarizing plate was measured using a potential meter (KSD-0103 manufactured by KASUGA ELECTRIC WORKS LTD.) fixed at a predetermined position. The distance between the sample and the potential meter was 100 mm during the measurement on the surface of the acrylic plate. Herein, the measurement was performed in an environment at 23° C. and 24±2% RH.

The pressure-sensitive adhesive sheet of the present invention preferably has a peeling electrification voltage (absolute value) of 1.0 kV or less, more preferably 0.5 kV or less. If the peeling electrification voltage exceeds 1.0 kV, adsorption of dust can easily occur during the peeling off of the pressure-sensitive adhesive sheet, which is not preferred.

### (2) Ability to Prevent Increase in Adhesive Strength (Peel Strength) (Initial Adhesive Strength)

The prepared pressure-sensitive adhesive sheet was cut into a piece with a size of 25 mm in width and 100 mm in length, and the separator was peeled off. Using a laminator (Compact Laminator manufactured by TESTER SANGYO CO., LTD.), the resulting piece was then laminated onto a polarizing plate (SEG1425DU manufactured by NITTO DENKO CORPORATION, 70 mm wide, 100 mm long) under the conditions of 0.25 MPa and 0.3 m/minute to form an evaluation sample. After the lamination, the sample was allowed to stand in an environment at 23° C. and 50% RH for 30 minutes and then measured for adhesive strength (N/25 mm) at a peel angle of 180° and a peeling rate of 30 m/minute using a universal tensile tester. The measured adhesive strength was called the “initial peel strength (adhesive strength).” Herein, the measurement was performed in an environment at 23° C. and 50% RH.

The pressure-sensitive adhesive sheet of the present invention preferably has an initial peel strength of 0.1 to 0.8 N/25 mm, more preferably 0.2 to 0.7N/25 mm, even more preferably 0.2 to 0.6 N/25 mm, further more preferably 0.2 to 0.5 N/25 mm. The pressure-sensitive adhesive sheet with an adhesive strength of 0.8 N/25 mm or less is preferable in that it can be easily peeled off to make productivity or handleability higher in the process of manufacturing polarizing plates or liquid crystal display devices. The pressure-sensitive adhesive sheet with an adhesive strength of 0.1 N/25 mm or more is preferable in that it can be prevented from lifting or peeling in manufacturing processes and can sufficiently function as a surface protecting sheet.

(Peel Strength after Bonding and Storing at 40° C. For 1 Week (Peel Strength Over Time))

The sample obtained by laminating the pressure-sensitive adhesive sheet and the polarizing plate was stored in an environment at 40° C. for 1 week and then allowed to stand in an environment at 23° C. and 50% RH for 2 hours. The sample was then subjected to a 180° peel test at a peeling rate of 30 m/minute, in which the adhesive strength (N/25 mm) between the pressure-sensitive adhesive sheet and the polarizing plate was measured and called the “peel strength (adhesive strength) over time.”

If the difference between the peel strength over time and the initial peel strength [(the peel strength over time)−(the initial peel strength)] is less than 0.5 N/25 mm, the pressure-sensitive adhesive sheet can be judged to be superior in the ability to prevent an increase in adhesive strength (peel strength). The difference between the peel strength over time and the initial peel strength [ (the peel strength over time)−(the initial peel strength)] of the pressure-sensitive adhesive sheet of the present invention is preferably less than 0.5 N/25 mm, more preferably 0.0 to 0.2 N/25 mm. If the difference is 0.5 N/25 mm or more, the ability to prevent an increase in adhesive strength can be poor, so that the workability of removal of the pressure-sensitive adhesive sheet may degrade in some cases.

### (3) Less-Staining Properties (White Staining) [Humidity Test]

Using a laminator (Compact Laminator manufactured by TESTER SANGYO CO., LTD.), the pressure-sensitive adhesive sheet (sample size: 25 mm wide and 100 mm long) obtained in each of the examples and the comparative examples was laminated onto a polarizing plate (SEG1425DU (trade name) manufactured by NITTO DENKO CORPORATION, size: 70 mm wide and 120 mm long) under the conditions of 0.25 MPa and 0.3 m/minute.

The laminate composed of the polarizing plate and the pressure-sensitive adhesive sheet bonded thereto was allowed to stand at 80° C. for 4 hours, and then the pressure-sensitive adhesive sheet was peeled off. The polarizing plate obtained by peeling off the pressure-sensitive adhesive sheet was then allowed to stand in a humidified environment (23° C., 90% RH) for 12 hours. The surface of the polarizing plate was then visually observed and evaluated for less-staining properties according to the criteria shown below. If white staining occurs on the polarizing plate as the adherend under the humid conditions (high-humidity conditions) after the bonding and peeling off of the pressure-sensitive adhesive sheet, the less-staining properties of the pressure-sensitive adhesive sheet can be judged to be not enough for optical member surface-protecting film applications.

Good level of less-staining properties (o): No change was observed in the part where the pressure-sensitive adhesive sheet had been bonded and in the part where it had not been bonded.

Poor level of less-staining properties (x): White staining was observed in the part where the pressure-sensitive adhesive sheet had been bonded.

TABLE 5

| | | | Example | | | | | Comparative Example | | | | | |
|---|---|---|---|---|---|---|---|---|---|---|---|---|---|
| Components and evaluation results | | | 3-1 | 3-2 | 3-3 | 3-4 | 3-5 | 3-1 | 3-2 | 3-3 | 3-4 | 3-5 | 3-6 |
| Acrylic | Raw | 2EHA | 96 | 96 | 96 | 96 | 98 | 96 | 96 | 96 | 96 | 96 | 85 |
| emulsion | material | AA | 4 | 4 | 4 | 4 | 2 | 4 | 4 | 4 | 4 | 4 | 15 |
| polymer | monomers | MMA | | | | 4 | | | | | | | |
| | Emulsifier | HS-1025 | 3 | 3 | 3 | 3 | 3 | 3 | 3 | 3 | 3 | 3 | 3 |
| Removable | Acrylic emulsion polymer | | 100 | 100 | 100 | 100 | 100 | 100 | 100 | 100 | 100 | 100 | Pressure-sensitive |
| water- | Non-water- | TETRAD-C | 2 | 2.5 | 2 | 2.5 | 2 | 2 | 2.5 | 2.5 | | 2.5 | adhesive sheet was |
| dispersible | soluble | | | | | | | | | | | | not able to be |
| acrylic | crosslinking | | | | | | | | | | | | prepared due to |
| pressure- | agent | | | | | | | | | | | | formation of |
| sensitive | Water- | EX-512 | | | | | | | | | 4.6 | | aggregate during |
| adhesive | soluble | | | | | | | | | | | | preparation of |
| composition | crosslinking | | | | | | | | | | | | acrylic emulsion |
| | agent | | | | | | | | | | | | polymer. |
| | Antistatic | LiCF₃SO₃ | 1 | 1 | 1 | 1 | 1 | | 1 | | | | |
| | agent | SF-106 | | | | | | | | | | 1 | |
| | Polyether | 17R-4 | 1 | | | 1 | 1 | | | | | | |
| | antifoamer | 17R-2 | | 1 | | | | | | | | | |
| | | L-62 | | | 1 | | | | | | | | |
| | PEG-2000 | | | | | | | | | 3 | | | |
| Evaluation | Peeling | | 0.0 | 0.0 | 0.0 | 0.0 | 0.0 | 2.6 | 1.5 | 2.4 | 2.3 | 2.6 | |
| results | electrification | | | | | | | | | | | | |
| | voltage (absolute | | | | | | | | | | | | |
| | value) (kV) | | | | | | | | | | | | |
| | Peel strength | Initial | 0.5 | 0.4 | 0.4 | 0.2 | 0.5 | 0.9 | 0.6 | 0.8 | 1.5 | 0.5 | |
| | (N/25 mm) | peel | | | | | | | | | | | |
| | to DU | strength | | | | | | | | | | | |
| | | Peel | 0.5 | 0.4 | 0.4 | 0.2 | 0.6 | 0.9 | 0.6 | 0.8 | 1.4 | 0.5 | |
| | | strength | | | | | | | | | | | |
| | | over time | | | | | | | | | | | |

| | | | | | | | | | | |
|---|---|---|---|---|---|---|---|---|---|---|
| Less-staining properties | ∘ | ∘ | ∘ | ∘ | ∘ | ∘ | ∘ | ∘ | x | x |

In Table 5, the weight of the solid is shown with respect to each component. Herein, the following abbreviations are used in Table 5.

2EHA: 2-ethylhexyl acrylate

MMA: Methyl methacrylate

AA: Acrylic acid

HS-1025: AQUALON HS-1025 (trade name) manufactured by Dai-ichi Kogyo Seiyaku Co., Ltd. (a reactive nonionic-anionic emulsifier)

TETRAD-C: TETRAD-C (trade name) manufactured by MITSUBISHI GAS CHEMICAL COMPANY, INC. (1,3-bis(N,N-diglycidylaminomethyl)cyclohexane, 110 in epoxy equivalent, 4 in the number of functional groups) (a non-water-soluble crosslinking agent)

EX-512: Denacol EX-512 (trade name) manufactured by Nagase ChemteX Corporation (polyglycerol polyglycidyl ether, 168 in epoxy equivalent, 4 in the number of functional groups) (a water-soluble crosslinking agent)

LiCF₃SO₃: Lithium trifluoromethanesulfonate, which is an alkali metal salt containing fluorine (an antistatic agent)

SF-106: ADEKA MINE SF-106 (trade name) manufactured by ADEKA CORPORATION (dimethyldialkyloxyethyleneammonium chloride (a non-alkali-metal salt, 80% by weight in solid content) (an antistatic agent)

17R-4: ADEKA PLURONIC 17R-4 (trade name) manufactured by ADEKA CORPORATION (a polyether antifoamer, 2,500 in number average molecular weight, 40% by weight in EO content)

17R-2: ADEKA PLURONIC 17R-2 (trade name) manufactured by ADEKA CORPORATION (a polyether antifoamer, 2,000 in number average molecular weight, 20% by weight in EO content)

L-62: ADEKA PLURONIC L-62 (trade name) manufactured by ADEKA CORPORATION (a polyether antifoamer, 2,200 in number average molecular weight, 20% by weight in EO content)

PEG-2000: Polyethylene Glycol 2000 (trade name) manufactured by Kanto Chemical Co., Inc. (polyethylene glycol, 2000 in number average molecular weight)

From the evaluation results in Table 5, it has been found that in all the examples, the resulting pressure-sensitive adhesive layers (pressure-sensitive adhesive sheets) are superior not only in antistatic properties, removability, and the ability to prevent an increase in adhesive strength over time, but also in less-staining properties on adherends, especially, the ability to prevent white staining on adherends in a high-humidity environment (the ability to prevent white staining). In particular, the results suggest that when a polyether antifoamer is used in combination with an alkali metal salt, they can be moderately transferred to the adherend interface so that antistatic properties can be achieved.

On the other hand, a very high peeling electrification voltage and a high initial peel strength were observed in Comparative Example 3-1 where neither alkali metal salt as an antistatic agent nor polyether antifoamer was added. An increase in peeling electrification voltage was observed in Comparative Example 3-2 where an alkali metal salt was added but no polyether antifoamer was added. A high peeling electrification voltage and an initial peel strength higher than those in the examples (although falling within the desired range) were observed in Comparative Example 3-3 where no antistatic agent was added and polyethylene glycol was added instead of the polyether antifoamer. As a result, a high peeling electrification voltage, a high initial peel strength, and a poor level of less-staining properties were obtained in Comparative Example 3-4 where neither antistatic agent nor polyether antifoamer was added. A high peeling electrification voltage and staining properties were observed in Comparative Example 3-5 where a surfactant of a non-alkali-metal salt was added as an antistatic agent and no polyether antifoamer was added. In Comparative Example 3-6 where the content of acrylic acid as a carboxyl group-containing unsaturated monomer was high, the pressure-sensitive adhesive sheet was not able to be prepared due to the formation of an aggregate in the process of preparing the acrylic emulsion polymer.

### DESCRIPTION OF REFERENCE SIGNS

1: Potential meter
2: Pressure-sensitive adhesive sheet
3: Polarizing plate
4: Acrylic plate
5: Sample mount.

1. A removable water-dispersible acrylic pressure-sensitive adhesive composition, comprising:
an acrylic emulsion polymer comprising 70 to 99.5% by weight of a monomer unit derived from an alkyl(meth)acrylate and 0.5 to 10% by weight of a monomer unit derived from a carboxyl group-containing unsaturated monomer;
an ionic compound; and
a polyether antifoamer represented by formula (I):
HO—(PO)ₙ₁-(EO)ₘ₁—H (I)
wherein PO represents an oxypropylene group, EO represents an oxyethylene group, m1 represents an integer of 0 to 40, n1 represents an integer of 1 or more, and EO and PO are added in a random form or a block form.

2. The removable water-dispersible acrylic pressure-sensitive adhesive composition according to claim 1, wherein the ionic compound is an ionic liquid and/or an alkali metal salt.

3. The removable water-dispersible acrylic pressure-sensitive adhesive composition according to claim 2, wherein the ionic liquid is a non-water-soluble ionic liquid and/or a water-soluble ionic liquid.

4. The removable water-dispersible acrylic pressure-sensitive adhesive composition according to claim 2, wherein the ionic liquid contains at least one selected from the group consisting of cations represented by formulae (A) to (E): 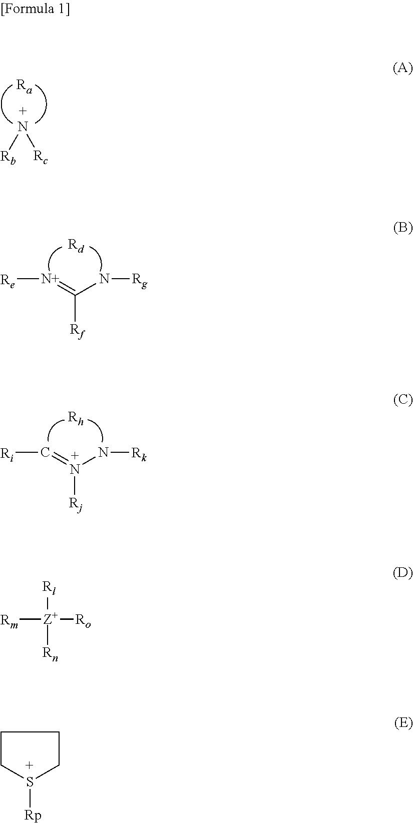
in formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent,
in formula (B), R_{d} represents a hydrocarbon group of 2 to 20 carbon atoms, part of the hydrocarbon group may be a heteroatom-substituted functional group, Rₑ, R_{f}, and R_{g} are the same or different and each represent hydrogen or a hydrocarbon group of 1 to 16 carbon atoms, and part of the hydrocarbon group may be a heteroatom-substituted functional group,
in formula (C), Rₕ represents a hydrocarbon group of 2 to 20 carbon atoms, part of the hydrocarbon group may be a heteroatom-substituted functional group, Rᵢ, Rⱼ, and Rₖ are the same or different and each represent hydrogen or a hydrocarbon group of 1 to 16 carbon atoms, and part of the hydrocarbon group may be a heteroatom-substituted functional group,
in formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent, and
in formula (E), Rₚ represents a hydrocarbon group of 1 to 18 carbon atoms, and part of the hydrocarbon group may be a heteroatom-substituted functional group.

5. The removable water-dispersible acrylic pressure-sensitive adhesive composition according to claim 2, wherein the ionic liquid is of at least one selected from the group consisting of an imidazolium-containing salt type, a pyridinium-containing salt type, a morpholinium-containing salt type, a pyrrolidinium-containing salt type, and a piperidinium-containing salt type.

6. The removable water-dispersible acrylic pressure-sensitive adhesive composition according to claim 2, wherein the ionic liquid contains at least one cation selected from the group consisting of cations represented by formulae (a) to (d): 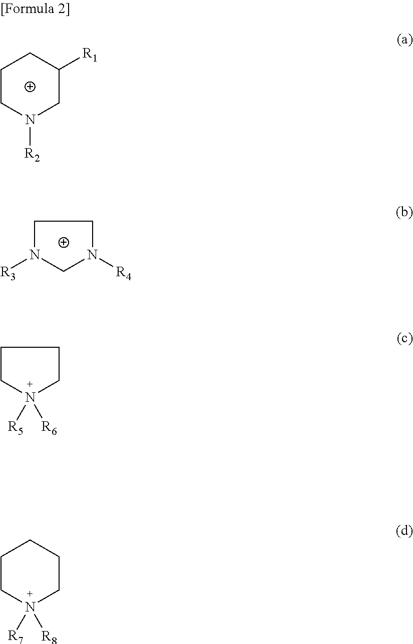
in formula (a), R₁ represents hydrogen or a hydrocarbon group of 1 to 3 carbon atoms, and R₂ represents hydrogen or a hydrocarbon group of 1 to 5 carbon atoms,
in formula (b), R₃ represents hydrogen or a hydrocarbon group of 1 to 3 carbon atoms, and R₄ represents hydrogen or a hydrocarbon group of 1 to 5 carbon atoms,
in formula (c), R₅ represents hydrogen or a hydrocarbon group of 1 to 3 carbon atoms, and R₆ represents hydrogen or a hydrocarbon group of 1 to 5 carbon atoms, and
in formula (d), R₇ represents hydrogen or a hydrocarbon group of 1 to 3 carbon atoms, and R₈ represents hydrogen or a hydrocarbon group of 1 to 5 carbon atoms.

7. The removable water-dispersible acrylic pressure-sensitive adhesive composition according to claim 2, wherein the ionic liquid contains a fluorine atom-containing anion.

8. The removable water-dispersible acrylic pressure-sensitive adhesive composition according to claim 2, wherein the ionic liquid contains a fluoroalkyl group-containing anion.

9. The removable water-dispersible acrylic pressure-sensitive adhesive composition according to claim 2, wherein the ionic liquid contains an imide group-containing anion.

10. The removable water-dispersible acrylic pressure-sensitive adhesive composition according to claim 2, which contains 10 parts by weight or less of the ionic liquid based on 100 parts by weight of the solid of the acrylic emulsion polymer.

11. The removable water-dispersible acrylic pressure-sensitive adhesive composition according to claim 2, wherein the alkali metal salt contains a fluorine-containing anion.

12. The removable water-dispersible acrylic pressure-sensitive adhesive composition according to claim 2, wherein the alkali metal salt is a lithium salt.

13. The removable water-dispersible acrylic pressure-sensitive adhesive composition according to claim 2, which contains 5 parts by weight or less of the alkali metal salt based on 100 parts by weight of the solid of the acrylic emulsion polymer.

14. The removable water-dispersible acrylic pressure-sensitive adhesive composition according to claim 1, wherein the polyether antifoamer is represented by formula (II):
HO—(PO)ₐ-(EO)_{b}—(PO)_{c}—H (II)
wherein PO represents an oxypropylene group, EO represents an oxyethylene group, and a to c each represent an integer of 1 or more.

15. The removable water-dispersible acrylic pressure-sensitive adhesive composition according to claim 1, wherein the polyether antifoamer has an oxypropylene content of 50 to 95% by weight.

16. The removable water-dispersible acrylic pressure-sensitive adhesive composition according to claim 1, wherein the polyether antifoamer has a number average molecular weight of 1,200 to 4,000.

17. The removable water-dispersible acrylic pressure-sensitive adhesive composition according to claim 1, which contains 10 parts by weight or less of the polyether antifoamer based on 100 parts by weight of the solid of the acrylic emulsion polymer.

18. The removable water-dispersible acrylic pressure-sensitive adhesive composition according to claim 1, wherein the acrylic emulsion polymer is a product of polymerization with a reactive emulsifier containing a radically-polymerizable functional group in its molecule.

19. The removable water-dispersible acrylic pressure-sensitive adhesive composition according to claim 1, further comprising a non-water-soluble crosslinking agent having two or more functional groups per molecule, wherein the functional groups are capable of reacting with a carboxyl group.

20. A pressure-sensitive adhesive sheet, comprising:
a substrate; and
a pressure-sensitive adhesive layer formed on at least one side of the substrate and made from the removable water-dispersible acrylic pressure-sensitive adhesive composition according to claim 1.

21. The pressure-sensitive adhesive sheet according to claim 20, which is a surface protecting film for use on an optical member.

22. An optical member comprising the pressure-sensitive adhesive sheet according to claim 21 as a bonded component.
